(19) United States
(12) Patent Application Publication
(10) Pub. No.: US 2026/0080281 A1
(43) Pub. Date: Mar. 19, 2026

(54) ZERO-KNOWLEDGE PROOF OF TRANFORMER MODEL BASED ON GAUGE TRANSFORMATION

(71) Applicant: Intel Corporation, Santa Clara, CA (US)

(72) Inventor: Hong Wang, Santa Clara, CA (US)

(73) Assignee: Intel Corporation, Santa Clara, CA (US)

(21) Appl. No.: 19/396,819

(22) Filed: Nov. 21, 2025

Related U.S. Application Data
(60) Provisional application No. 63/878,601, filed on Sep. 9, 2025.

(51) Int. Cl. G06N 5/04

(52) U.S. Cl. CPC G06N 5/04

(57) ABSTRACT

One or more inference processes may be performed in the deployment of a transformer model. For proving correctness of a transformer model inference, a ZKP may be generated in two stages. In the first stage, PoGE may be generated by canonicalizing deployed weights of the transformer model through gauge transformation to produce canonical weights. A canonical model may be generated by modifying the transformer model with the canonical weights. In the second stage, PoVI may be generated. The canonical model may be executed to generate an output from an input. The output of the canonical model may be bit-identical as the output of the transformer model for the same input despite the weight canonicalization. The ZKP for the transformer model inference may include the PoGE and PoVI. The PoGE may be generated once and used for many inference processes. The PoVI may be generated per inference.

### CROSS-REFERENCE TO RELATED APPLICATION

This application claims the benefit of U.S. Provisional Patent Application No. 63/878,601, filed Sep. 9, 2025, and entitled “EFFICIENT MECHANISM FOR ZERO-KNOWLEDGE PROOFS OF TRANSFORMERS,” which is incorporated by reference in its entirety.

### TECHNICAL FIELD

This disclosure relates generally to artificial intelligence (AI), and more specifically, zero-knowledge proof (ZKP) of transformer models based on gauge transformation.

### BACKGROUND

Neural networks (also referred to as “deep neural networks” or “DNNs”) are used extensively for a variety of AI applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates an example transformer model, in accordance with various embodiments.

FIG. 2 illustrates an example embedding layer, in accordance with various embodiments.

FIG. 3 illustrates positional encoding, in accordance with various embodiments.

FIGS. 4A and 4B illustrate an example multi-head attention (MHA) layer, in accordance with various embodiments.

FIG. 5 illustrates an example linear classifier, in accordance with various embodiments.

FIG. 6 illustrates a first inference stage of a transformer model, in accordance with various embodiments.

FIG. 7 illustrates subsequent inference stages of the transformer model, in accordance with various embodiments.

FIG. 8 illustrates an AI environment, in accordance with various embodiments.

FIG. 9 is a block diagram of an AI system, in accordance with various embodiments.

FIG. 10 illustrates a two-stage proof architecture, in accordance with various embodiments.

FIG. 11 illustrates advantages of two-stage ZKP for circuit implementation, in accordance with various embodiments.

FIG. 12 illustrates a dataflow in an attention layer during transformer model inference for deployment, in accordance with various embodiments.

FIG. 13 illustrates a dataflow in an attention layer during canonical model inference for verification, in accordance with various embodiments.

FIG. 14 is a flowchart of a method for proving correctness of transformer model inference, in accordance with various embodiments.

FIG. 15 is a block diagram of an example computing device, in accordance with various embodiments.

### DETAILED DESCRIPTION

The last decade has witnessed a rapid rise in AI based data processing, particularly based on neural networks (also referred to as deep neural networks (DNNs)). DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, MatMul operation, layer normalization, batch normalization, activator operations (e.g., Sigmoid linear unit (SiLU) operation, SoftMax operation, etc.), pooling, elementwise operation, linear operation, non-linear operation, and so on.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), 3D tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

Deploying transformer models (e.g., large language models) in sensitive settings creates a need for verifiable inference, such as need for proof that outputs were computed correctly without revealing proprietary weights or private inputs. Zero-knowledge machine learning (ZKML) offers this. ZKP is a cryptographic method where one party can prove to another that a statement is true, without revealing any information beyond the validity of the statement itself. This can be achieved by providing proof without revealing the underlying data. A ZKP usually involves a “prover” who has a piece of secret information and a “verifier” who wants to confirm the prover's claim. In situations where the statement is true, the verifier learns nothing new besides the fact that the statement is true. The secret information is not revealed. A ZKML may be a cryptographic protocol where the party that computes the output on an AI model given an input also generates cryptographic proof that effectively proves something about the computation.

However, currently available ZKP systems struggle to scale to transformer architectures. Currently available ZKML systems suffer from prohibitive computational costs that scale linearly with the number of model parameters, making verification of large language models economically infeasible for production deployment. Currently available frameworks typically compile networks into polynomial constraint systems. Prove cost is usually dominated by the number of constraints (e.g., roughly linear in parameter count). Cryptographic advances (e.g., look-ups, sum check, commitments) can accelerate the protocol layer, but they do not remove the model-level redundancy intrinsic to attention, leaving many constraints structurally unnecessary.

Currently available approaches include circuit-based compilation frameworks. A prevalent approach to ZKML is the development of circuit compilation frameworks, with Easy Zero-Knowledge Inference (EZKL) representing the current state of the art. These systems typically translate neural network computations into arithmetic constraint systems that can be verified using established cryptographic protocols. The framework can convert each matrix multiplication, activation function, and normalization operation into polynomial constraints over finite fields. While this approach can enable zero-knowledge proof for neural networks, it suffers from fundamental scalability limitations.

These circuit-based systems usually treat every model parameter as an independent variable requiring separate cryptographic commitments and constraints. For transformer models, this can result in circuit sizes that grow linearly with parameter count, generating hundreds of millions of gates for even modest-scale models. The experimental data shows that EZKL requires approximately 198 million gates for a 117 million parameter GPT-2 Base model, with proving times exceeding 280 seconds and memory consumption of 85 gigabytes. This direct translation approach fails to recognize or exploit the inherent mathematical redundancies within transformer architectures.

Currently available approaches also include zero-knowledge virtual machine approaches. This alternative strategy emerges through zero-knowledge virtual machines such as RISC Zero's zkVM and SP1. These systems can compile machine learning inference into general-purpose instruction sequences executed within a verifiable virtual machine environment. The approach can provide flexibility by supporting arbitrary computation patterns without requiring specialized circuits for each operation type.

However, the virtual machine abstraction usually introduces significant overhead through instruction emulation and memory management. Experimental comparisons demonstrate that RISC Zero requires even more computational resources than direct circuit compilation, with 216 million gates and 312 seconds of proving time for the same GPT-2 Base model. The general-purpose nature of these virtual machines can prevent them from exploiting the specific algebraic structure of transformer computations, resulting in inefficient proof generation that scales poorly with model size.

Some currently available approaches provide protocol-level cryptographic optimizations. Substantial research effort has focused on improving the underlying cryptographic protocols used for proof generation. Advances in look-up arguments can reduce the cost of verifying non-linear operations such as exponentials and reciprocals. Sumcheck protocols can improve the efficiency of polynomial evaluations, while developments in polynomial commitment schemes can reduce proof sizes and verification times. Systems implementing these optimizations, including Bulletproofs and various folding schemes, can achieve meaningful improvements in prover performance.

Nevertheless, these protocol-level optimizations typically operate on the cryptographic machinery without addressing the fundamental redundancy in the computation being verified. They can accelerate the proving process for a given circuit but cannot reduce the circuit size itself. When applied to transformer models, these improvements would provide linear speedups that fail to overcome the exponential growth in computational requirements as models scale to billions of parameters.

Some currently available approaches are related to model compression and approximation techniques. Some approaches have attempted to reduce proof complexity by modifying the model itself through quantization, pruning, or knowledge distillation. Quantization can reduce the bit-width of model parameters, decreasing the field arithmetic complexity. Pruning can remove parameters entirely, creating sparse models with fewer operations to verify. Knowledge distillation can train smaller models to approximate larger ones, reducing the parameter count that requires verification.

These compression techniques fundamentally alter the model's computation and introduce approximation errors that violate the exactness requirements of cryptographic verification. In applications requiring regulatory compliance or security guarantees, any deviation from the exact model computation can undermine the verification's validity. Furthermore, compressed models often exhibit degraded performance on complex tasks, limiting their applicability in production scenarios where both accuracy and verifiability are essential.

Currently available approaches also include industrial deployments and hybrid approaches. Commercial implementations such as zkLLM and Giza Tech have attempted to make zero-knowledge proof generation practical through various engineering optimizations. These systems typically employ batching strategies to amortize fixed costs across multiple inferences, implement caching mechanisms to reuse intermediate computations, and utilize specialized hardware accelerators for field arithmetic operations.

While these industrial solutions usually have feasibility for moderate-scale deployments, they remain fundamentally constrained by the linear scaling relationship between model parameters and proof complexity. The engineering optimizations can provide constant-factor improvements but cannot overcome the asymptotic barriers that prevent verification of large language models with billions of parameters. Production deployments remain limited to smaller models or require prohibitive computational resources that make them economically unviable for high-throughput applications.

Embodiments of this disclosure may improve on at least some of the challenges and issues described above by providing GaugeZKP, a two-stage approach to generate ZKP for transformers models by exploiting their inherent gauge symmetry structure. In an example, GaugeZKP may separate concerns between parameter equivalence and inference correctness. The first stage may be the generation of a one-time Proof of Gauge Equivalence (PoGE), which can cryptographically demonstrate that the deployed model parameters are functionally identical to a predetermined canonical form. This canonical form may represent a unique representative chosen from each equivalence class of parameters through a systematic gauge-fixing procedure. The second stage includes Proof of Verifiable Inference (PoVI) operations that verify computation using the canonical weights in lieu of the deployed weights, eliminating the need to repeatedly prove constraints for redundant parameters. GaugeZKP can eliminate inherent algebraic redundancies of transformer models where multiple distinct parameter configurations compute identical functions from the verification process.

In various embodiments of this disclosure, a transformer model may be deployed to perform one or more AI tasks. The deployment may include one or more inference processes, each of which may include executing the transformer model to generate an output from an input. Proof may be requested to verify that the inference processes were done correctly. A ZKP may be generated for proving correctness of a transformer model inference without sharing proprietary data. The ZKP may be generated in two stages. In the first stage, PoGE may be generated by canonicalizing weights of the transformer model that are used to perform the inference. These weights may be referred to as deployed weights. The deployed weights may be canonicalized through gauge transformation. The resulting weights may be referred to as canonical weights. A canonical model may be generated by modifying the transformer model with the canonical weights. In situations where the transformer model employs rotary position embeddings (ROPE), the PoGE generate may adapt to the restricted gauge structure by working within the commutant algebra of rotation matrices. The canonical model may have the same architecture as the transformer model. For instance, the canonical model may have the same layers, which are arranged in the same order, as the transformer model. An attention layer may be permuted by reordering the heads within the attention layer. The PoGE may prove that the head reording is a pure permutation. The output of the attention layer (or the output of the transformer model) may remain unchanged despite the weight canonicalization. In the second stage, PoVI may be generated. The canonical model may be executed to generate an output from an input. The input may be provided by the verifier to have an interactive ZKP generation process. Alternatively, the input may be a random input (e.g., random vectors) generated by the prover using Fiat-Shamir transformation so that the ZKP generation process can be non-interactive. PoGE may be generated once and may be reused for many inference processes. PoVI may be generated per inference.

The two-stage ZKP approach in this disclosure can identify and eliminate redundancy at the circuit level. For many transformers (such as standard transformers), the two-stage ZKP approach can exploit the full general linear group symmetry in both query-key and value-output pathways, reducing verification complexity by the square of the hidden dimension per attention head. For architectures using ROPE, this approach can adapt to the constrained symmetry structure by working within the commutant algebra, maintaining correctness while preserving substantial efficiency gains. This approach can achieve a paradigm shift from treating model parameters as independent variables to recognizing their algebraic relationships and exploiting these relationships for computational reduction. By proving equivalence to a canonical form once and conducting all subsequent verification on that simplified representation, this approach can eliminate millions of redundant constraints while maintaining exact functional equivalence and complete zero-knowledge properties. The result can be a significant reduction in verification costs (e.g., a reduction of up to 26%) at production scale, making real-time verifiable inference economically feasible for large language models for the first time.

The two-stage ZKP approach can address the fundamental computational inefficiency in generating cryptographic zero-knowledge proofs for transformer-based DNN inference. This approach can resolve several interconnected technical problems that have prevented practical deployment of verifiable transformer inference. First, current zero-knowledge proof systems treat every parameter in a transformer model as an independent variable requiring separate cryptographic constraints, despite the mathematical reality that large families of these parameters are functionally redundant under algebraic transformations. For a typical 110 million parameter transformer, existing systems usually generate circuits with over one million unnecessary constraints due to this redundancy. Second, this approach can address the repeated computation problem that every inference verification needs to prove the entire model from scratch, including verification of weight matrices that remain constant across multiple inference requests. This can create an untenable economic burden where each proof generation consumes computational resources proportional to the full model size, regardless of the simplicity of the actual inference task. Third, this approach can solve the architectural incompatibility between transformer symmetrical structures and cryptographic constraint systems.

The approach in this disclosure can enable regulatory compliance and trust. This approach can address critical compliance requirements emerging across regulated industries where AI systems are expected or required to provide auditable guarantees of correct computation. Healthcare organizations can prove that diagnostic recommendations follow from verified model inference without exposing proprietary training data or patient information. Financial services firms can demonstrate that loan decisions and risk assessments are computed correctly according to approved models, satisfying regulatory scrutiny while protecting competitive advantages embedded in their model architectures.

The approach can enable a new paradigm of trusted AI where model providers can offer cryptographic guarantees about their systems' behavior without revealing intellectual property. This capability becomes increasingly valuable as regulatory frameworks mandate explainability and auditability for AI systems deployed in critical applications. Organizations can proactively demonstrate compliance rather than reactively responding to regulatory inquiries, reducing legal risk and accelerating deployment timelines.

The approach in this disclosure can fundamentally transform the economics of deploying verifiable AI systems at enterprise scale. By significantly reducing verification costs (e.g., up to 26% reduction) while maintaining exact computational guarantees, the technology can make it financially viable for organizations to implement cryptographic proof systems for production language models for the first time. This cost reduction can directly translate to operational savings that compound with usage volume, creating increasingly favorable unit economics as deployment scales. The amortization model introduced by the proof decomposition architecture can provide particularly compelling value for high-throughput applications. Organizations may generate the PoGE once for their deployed model, then leverage this single proof across millions of inference requests. This economic structure can align perfectly with enterprise deployment patterns where a single model version serves numerous customers and applications over extended periods. Financial institutions processing thousands of automated decisions daily can provide cryptographic verification for each decision without prohibitive computational overhead.

The approach in this disclosure can also provide ecosystem integration and multiplicative benefits. This disclosure's design as a model-level optimization that operates upstream of existing cryptographic protocols can create multiplicative value when combined with current zero-knowledge frameworks. Organizations already invested in currently available proof systems can integrate gauge symmetry optimization without replacing their existing infrastructure, immediately realizing performance improvements on their current technology stack. This compatibility can preserve ecosystem investments while delivering substantial efficiency gains. The modular architecture can support diverse deployment patterns that accommodate different trust models and operational requirements. Cloud providers can offer verified inference endpoints where they generate proofs on behalf of customers, while enterprises can operate their own proving infrastructure for maximum security. The flexibility to separate gauge equivalence proofs from inference proofs can enable specialized service providers to emerge, creating a rich ecosystem of verification services that drive down costs through competition and specialization. Companies can credibly claim superior governance and risk management capabilities backed by cryptographic proofs rather than procedural assertions. This technical differentiation approach can be particularly valuable in procurement processes where verifiable guarantees can satisfy security requirements that would otherwise exclude AI solutions.

As transformer models continue growing in size and capability, the percentage savings from eliminating redundant parameter verification can become increasingly significant in absolute terms. The mathematical principles underlying the approach can apply broadly to neural architectures beyond transformers, suggesting potential for expanded applications as the technology matures. Furthermore, the approach's emphasis on exploiting algebraic structure rather than engineering optimizations can position adopters to benefit from continued theoretical advances in understanding neural network symmetries. Organizations building expertise in gauge-theoretic optimization can be best positioned to leverage future discoveries that further reduce verification complexity. This can create a sustainable competitive advantage based on mathematical insight rather than temporary engineering advantages that competitors can readily replicate.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

FIG. 1 illustrates an example transformer model 100, in accordance with various embodiments. The transformer model 100 may transform input sequences into output sequences. In some embodiments, the transformer model 100 is a DNN that can learn context and meaning by tracking relationships in sequential data, such as sequential words in a sentence, sequential audio signals, sequential images, and so on. In an example, the transformer model 100 may be a large language model. The transformer model 100 includes an encoder block 110, a decoder block 120, and a head block 130. In other embodiment, different or additional components may be included in the transformer model 100. Further, functionality attributed to a component of the transformer model 100 may be accomplished by a different component included in the transformer model 100 or a different model or module.

The encoder block 110 receives input sequences and generates matrix representations of the input sequences. In the embodiments of FIG. 1, the encoder block 110 receives an input 101 and generates an encoder output 102. The input 101 may be an input prompt. In some embodiments, the input 101 may include one or more input tokens, such as words, phrases, sentences, images, audio signals, other types of input tokens, or some combination thereof. In an example, the input 101 may include a prompt received from a user of the transformer model 100. The prompt may include a question or request made by the user. A word in the prompt may be an input token. The encoder output 102 may include one or more vectors that are contextualized representations of the input 101. Each vector in the encoder output 102 may represent a token in the input 101 with contextual understanding.

The encoder block 110 includes an embedding layer 113, a positional encoding layer 115, and a plurality of layers 140 (individually referred to as “layer 140”). In other embodiments, the encoder block 110 may have different, fewer, or more components. Also, the arrangement of the components in the encoder block 110 may be different from the arrangement shown in FIG. 1. For the purpose of illustration, the encoder block 110 has N layers in FIG. 1, where N is an integer. Each layer 140 may include one or more neural network operations. The layers 140 may transform a sequence of embeddings into a representation that encapsulates the learned information from the input 101. Different layers 140 may have different internal parameters, e.g., different weights, bias, or other types of internal parameters. In some embodiments, the layers 140 have identical components. The components in a layer 140 may be layers and may also be referred to as sub-layers of the layer 140. As shown in FIG. 1, a layer 140 includes four sub-layers: an MHA layer 141, an add & norm layer 142, a feed forward layer 143, and another add & norm layer 144.

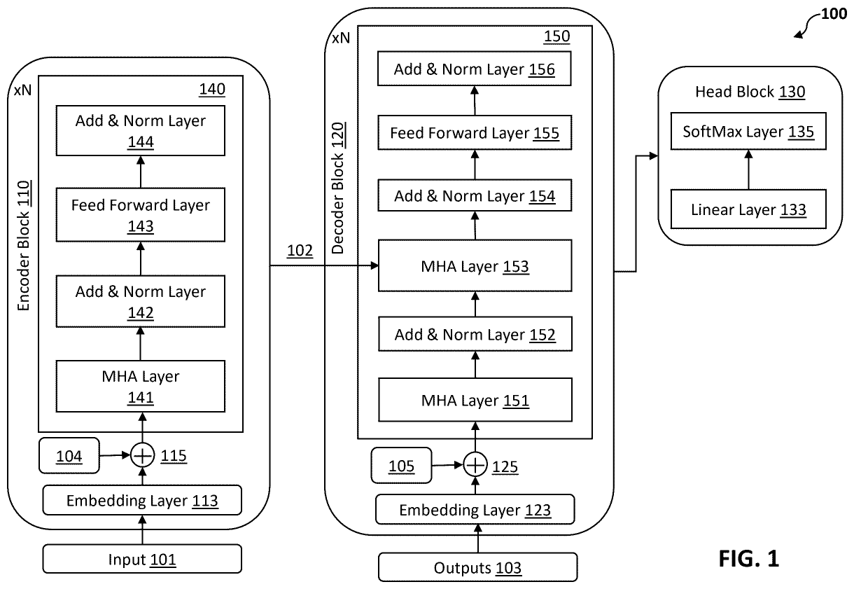

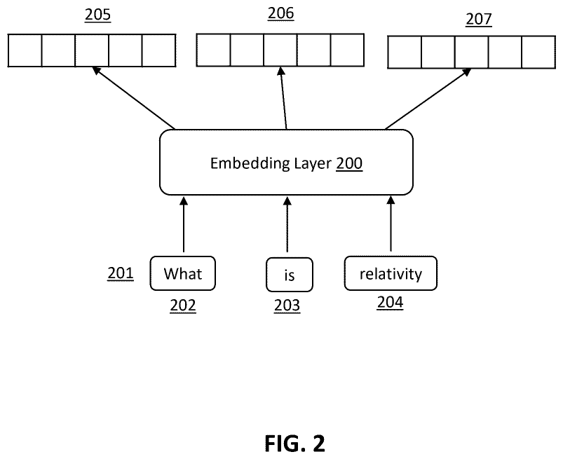

The decoder block 120 iteratively generates outputs 103 using encoded representations generated by the encoder block 110. The decoder block 120 includes an embedding layer 123, a positional encoding layer 125, and a plurality of layers 150 (individually referred to as “layer 150”). For the purpose of illustration, the decoder block 120 has N layers in FIG. 1, where N is an integer. In the embodiments of FIG. 2, the number of layers 150 in the decoder block 120 is the same as the number of layers 140 in the encoder block 110. In other embodiments, the number of layers 150 in the decoder block 120 may be different from the number of layers 140 in the encoder block 110. Each layer 150 may include one or more neural network operations. Different layers 150 may have different internal parameters. In some embodiments, the layers 150 may have identical components. The components in a layer 150 may be layers and may also be referred to as sub-layers of the layer 150. As shown in FIG. 1, a layer 150 includes six sub-layers: an MHA layer 151, an add & norm layer 152, an encoder-decoder attention layer 153, another add & norm layer 154, a feed forward layer 155, and another add & norm layer 156.

In some embodiments, a sequence of inference stages is performed in the decoder block 120 using encoder outputs, e.g., the encoder output 102. A matrix may be predicted through each inference stage. The outputs 103 may include a plurality of matrices. Each matrix may be further processed in the head block 130 to predict a token. The plurality of matrices may be used to predict a sequence of tokens. For the first inference stage, the decoder block 120 may receive one or more start tokens as input tokens and compute a first matrix from the input tokens and the output of the encoder block 110. The first matrix may be used by the head block 130 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 130 receives the output of the decoder block 120 and processes it in a linear layer 133 and a SoftMax layer 135. A linear operation may be performed on the output of the decoder block 120 in the linear layer 133. The linear operation may include a multiplication of the output of the decoder block 120 with a weight matrix. The output of the linear layer 133 may be a vector. In some embodiments, the head block 130 may function as a classifier. The number of data elements in the vector computed in the linear layer 133 may depend on the number of classes involved. In an example where there are M classes, where M is an integer, the vector computed in the linear layer 133 may have M data elements representing the prediction for the M classes, respectively.

The output of the linear layer 133 may be input into the SoftMax layer 135. A SoftMax function may be applied on the output of the linear layer 133 to compute probability scores. A probability score may have a value in the range from 0 to 1. In some embodiments, a probability value is computed for each data element in the vector computed in the linear layer 133. The highest one of the probability scores may be the key. The corresponding index of the key may point to the token that the transformer model 100 predicts as the next in the sequence. The final output of the transformer model 100 may be the sequence of predicted tokens. In some embodiments, the head block 130 may be a language modeling head.

An embedding layer (e.g., the embedding layer 113 or the embedding layer 123) converts an input of the embedding layer (e.g., the input 101 or the outputs 103) into one or more embeddings. An embedding may be a vector, which is also referred to as an embedding vector or a vector embedding. The vector embedding may include a sequence of data elements. In some embodiments, the embedding layer 113 may generate a plurality of embeddings, each of which may be converted from a different input token in the input 101. The embeddings may capture the semantic meaning of the tokens in the input 101. The embeddings may be numerical representations that capture the relationships or meanings of words, phrases, or other data types. In an example where the input 101 is a prompt including a sequence of words, the embedding layer 113 may generate an embedding from each word in the input 101. The embedding layer 123 in the decoder block 120 may generate a plurality of embeddings from tokens received by the decoder block 120 in a similar manner as the embedding layer 113. Certain aspects of embedding layers are described below in conjunction with FIG. 2.

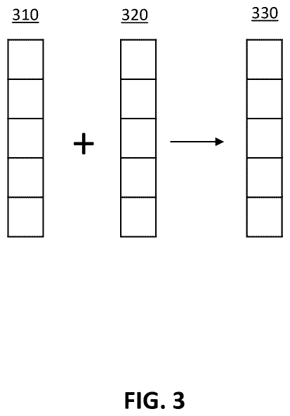

A positional encoding layer (e.g., the positional encoding layer 115 or the positional encoding layer 125) performs positional encoding on embeddings generated in the corresponding embedding layer. In some embodiments, the positional encoding layer may apply one or more positional encoding vectors (e.g., a positional encoding vector 104 or positional encoding vector 105) on vector embeddings from the corresponding embedding layer to generate new vector embeddings that represents the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer. Certain aspects of positional encoding layers are described below in conjunction with FIG. 3.

An MHA layer (e.g., the MHA layer 141, the MHA layer 151, or the MHA layer 153) may implement a multi-head attention mechanism, which may be a multi-head self-attention mechanism or a multi-head cross-attention mechanism. In some embodiments, the MHA layer 141 or the MHA layer 151 may implement a self-attention mechanism. For self-attention, the queries, keys, and values may come from the same place. For instance, for the MHA layer 141, the queries, keys, and values may all come from the positional encoding layer 115. For the MHA layer 151, the queries, keys, and values may all come from the positional encoding layer 125. The self-attention mechanism may enable the transformer model 100 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 141 may be computed from vector embeddings generated by the positional encoding layer 115. The queries, keys, and values input into the MHA layer 151 may be computed from vector embeddings generated by the positional encoding layer 125. A query, key, or value may be a vector the represents a token in a sequence. In some embodiments, a query matrix Q∈ [symbol] ^{N×h} may be computed by multiply an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiple an embedding matrix X∈ [symbol] ^{N×d} (e.g., an embedding matrix computed in a positional encoding layer) with a weight matrix Wₖ∈ [symbol] ^{d×h} Each row in the key matrix may be a key. A value matrix V∈ [symbol] ^{N×h} may be computed by multiple an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 151 may implement masked multi-head self-attention. The MHA layer 151 may prevent positions from attending to subsequent positions. For instance, each token in the sequence may not be influenced by future tokens. This masking can ensure that the predictions of a particular position can depend on known outputs at positions before it and not depend on unknown outputs at positions after it.

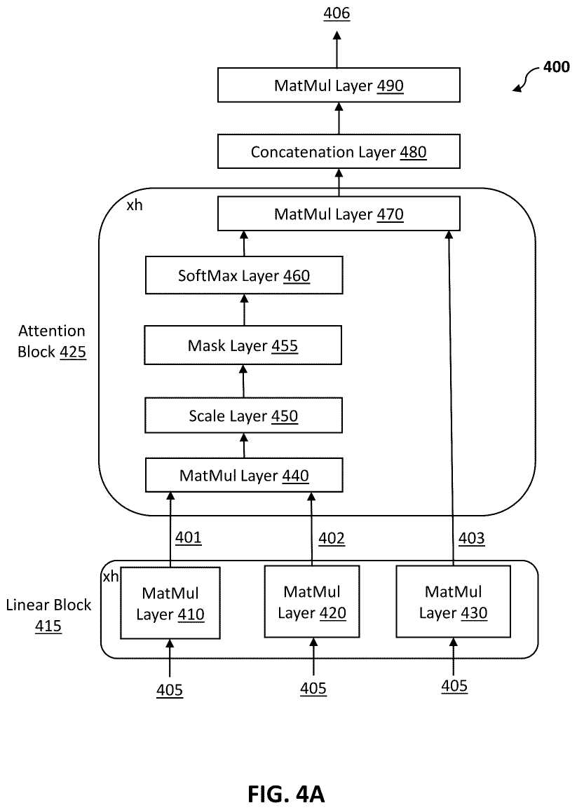

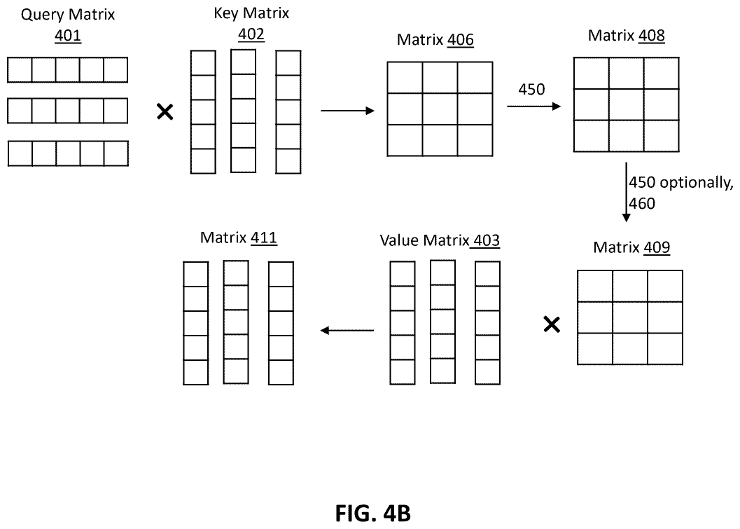

In some embodiments, the MHA layer 153 may implement a cross-attention mechanism, such as encoder-decoder cross-attention. The MHA layer 153 may use outputs from the previous layer (i.e., the add & norm layer 152) as queries and use outputs from the encoder block 110 as keys and values. The cross-attention can align the encoder's input with the decoder's, empowering the decoder block 120 to identify and emphasize the most relevant parts of the encoder's input. Certain aspects of MHA layers are described below in conjunction with FIGS. 4A and 4B.

An add & norm layer in the transformer model 100, such as the add & norm layer 142, 144, 152, 154, and 156, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 142 is the MHA layer 141. As another example, the preceding layer of the add & norm layer 154 is the encoder-decoder attention layer 153.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{xy} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${{σ}^{2}}_{xy} = {\sum }_{z = 1}^{Z} {{D}^{2}}_{xyz}$$

and a division computation denoted as

$${M}_{xy} = \frac{1}{\sqrt{\frac{1}{Z} \times ( {{σ}^{2}}_{xy} + ϵ \times Z )}} \cdot {M}_{xy}$$

may be a 2D tensor. The layer normalization operation may also convert M_{xy} to a 3D tensor M_{xyz}, e.g., by replicating every data element over z output points. Further, the layer normalization operation may have an element multiplication denoted as

$${{A}^{′}}_{xyz} = \frac{{A}_{xyz} - {μ}_{xyz}}{\sqrt{\frac{1}{Z} \times ( {{σ}^{2}}_{xy} + ϵ )}} = ( {A}_{xyz} - {μ}_{xyz} ) \times \frac{1}{\sqrt{\frac{1}{Z} \times ( {{σ}^{2}}_{xy} + ϵ )}} = {D}_{xyz} \times {M}_{xyz} .$$

The layer normalization operation may further compute

$${{A}^{″}}_{xyz} = {{A}^{′}}_{xyz} + \frac{{β}_{z}}{{γ}_{z}} and {LN}_{xyz} = {{A}^{″}}_{xyz} \times {γ}_{z} \cdot {LN}_{xyz}$$

may be the output of the layer normalization operation.

A feed forward layer (e.g., the feed forward layer 143 and the feed forward layer 155) may be a position-wise fully-connected feed forward network. In an example, the feed forward layer may include two linear layers with an activation function in between. An example of the activation function is Rectified Linear Unit (ReLU).

FIG. 2 illustrates an embedding operation in an embedding layer 200, in accordance with various embodiments. The embedding layer 200 may be an example of the embedding layer 113 or the embedding layer 123 in FIG. 1. As shown in FIG. 2, the embedding layer 200 receives an input sequence 201, which includes three words 202, 203, and 204. Each word may be a token. The embedding layer 200 generates a vector embedding 205 from the word 202. The embedding layer 200 also generates a vector embedding 206 from the word 203. The embedding layer 200 further generates a vector embedding 207 from the word 204. In the embodiments of FIG. 2, the vector embeddings 205, 206, and 207 have the same dimension, i.e., they each have five data elements. In other embodiments, the vector embedding 205, 206, or 207 may have a different dimension. Also, the input to the embedding layer 200 may be data of a type other than words, such as audio signals, images, and so on.

In some embodiments where the embedding layer 200 is in an encoder (e.g., the encoder block 110), the input sequence 201 may be an input received by the encoder, such as a prompt made by a user. The input sequence 201 may remain the same during inference of the encoder. In some embodiments where the embedding layer 200 is in a decoder (e.g., the decoder block 120), the input sequence 201 may change and the dimension of the input sequence 201 may be dynamic during inference of the decoder. In an example, the decoder inference may include a sequence of phases. Each inference stage may be conducted for predicting a token. For the first inference stage, the input sequence 201 may include one or more start tokens. For each subsequent inference stage (e.g., the second inference stage, the third inference stage, etc.), the input sequence 201 may include tokens predicted in the previous inference stages. The dimension of the input sequence may be increased by one after each inference stage.

FIG. 3 illustrates a positional encoding operation in a positional encoding layer, in accordance with various embodiments. The positional encoding layer may be an example of the positional encoding layer 115 or the positional encoding layer 125 in FIG. 1. The positional encoding operation includes an addition of a vector embedding 310 and a positional encoding vector 320. The vector embedding 310 may be generated by an embedding layer. The positional encoding vector 320 may encode information of the position of the token represented by the vector embedding 310 in a sequence of tokens. The positional encoding operation computes a vector embedding 330, which represents the token with positional context. In some embodiments, the positional encoding operation may be an elementwise addition operation. A data element in the vector embedding 330 may equal the sum of a data element in the vector embedding 310 and a data element in the positional encoding vector 320. In the embodiments of FIG. 3, the vector embedding 310, positional encoding vector 320, and vector embedding 330 have the same dimension, i.e., they each have five data elements. In other embodiments, the vector embedding 310, positional encoding vector 320, or vector embedding 330 may have a different dimension.

FIGS. 4A and 4B illustrate an example MHA layer 400, in accordance with various embodiments. The MHA layer 400 may be an example of the MHA layer 141 or the MHA layer 151 in FIG. 1. As shown in FIG. 4A, the MHA layer 400 includes linear layers 410, 420, and 430, a MatMul layer 440, a scale layer 450, a SoftMax layer 460, another MatMul layer 470, a concatenation layer 480, and another linear layer 490. In other embodiments, the MHA layer 400 may include fewer, more, or different layers. For instance, the scale layer 450 or mask layer 455 may be optional.

The MHA layer 400 receives an input 405. The input 405 may be token embeddings, which may be generated by an embedding layer or a positional encoding layer. The input 405 is fed into linear layers 410, 420, and 430 are in a linear block 415 of the MHA layer 400. In some embodiments, the MHA layer 400 includes a plurality of linear blocks that includes the linear block 415. For the purpose of illustration, the MHA layer 400 includes h linear blocks in FIG. 4A, where h is an integer. Each of the linear blocks may have the same layers as the linear block 415. Each linear block may compute three parameter matrices from the input 405. As shown in FIG. 4A, the linear layers 410, 420, and 430 outputs a query matrix 401, key matrix 402, and value matrix 403, respectively. In some embodiments, a MatMul operation in the linear layer 410 is applied on the input 405 and a query weight matrix

$${W}_{Q}^{i} ∈ {ℝ}^{{d}_{model} \times {d}_{q}} ,$$

which results in the query matrix 401. A MatMul operation in the linear layer 420 is applied on the input 405 and a key weight matrix

$${W}_{K}^{i} ∈ {ℝ}^{{d}_{model} \times {d}_{k}} ,$$

which results in key matrix 402. A MatMul operation in the linear layer 430 is applied on the input 405 and a value weight matrix

$${W}_{V}^{i} ∈ {ℝ}^{{d}_{model} \times {d}_{v}} ,$$

which results in the value matrix 403. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h.

The MatMul layer 440, scale layer 450, mask layer 455, SoftMax layer 460, and MatMul layer 470 are in an attention block 425 of the MHA layer. The attention block 425 may implement a scaled dot-product attention mechanism. In some embodiments, the MHA layer 400 includes a plurality of attention blocks that includes the attention block 425. For the purpose of illustration, the MHA layer 400 includes h attention blocks in FIG. 4A. Each of the attention blocks may have the same layers as the attention block 425. The linear block 415 and attention block 425 may constitute a head of the MHA layer 400. As the MHA layer 400 has h linear blocks and h attention blocks, the MHA layer 400 has h heads.

In some embodiments, for each head, the query matrix 401 and key matrix 402 are fed into the MatMul layer 440, where an MatMul operation may be performed on the query matrix 401 and key matrix 402, which computes a matrix 407 shown in FIG. 4B. The matrix 407 may be referred to as a dot-product matrix QK. In some embodiments, the matrix 407 may establish the degree of emphasis each token should place on other tokens. The matrix 407 may be a score matrix that includes a plurality of scores. Each token may be assigned a score in relation to other tokens within the same time step. A higher score may indicate a higher focus or emphasis. The matrix 407 may be scaled in the scale layer 450. In some embodiments, the matrix 407 is scaled down in the scale layer 450 by dividing the scores in the matrix 407 by the square root of the dimension of the query vector and the key vector, which may be denoted as \sqrt{dₖ}. The output of the scale layer 450 may be a scaled matrix 408, which may include adjusted scores.

The mask layer 455 may be optional in some embodiments. The mask layer 455 may add an attention mask (which may be an input to the attention block 425) to the scaled matrix 408 to mask out some elements in the scaled matrix 408. The positions of the masked-out elements may be defined by the attention mask. A SoftMax function of the SoftMax layer 460 may be applied on the output of the scale layer 450 or mask layer 455. The SoftMax function may emphasize high scores while diminishing low scores, which can enhance the model's ability to determine which tokens should get more attention. The SoftMax layer 460 outputs a matrix 409. The matrix 409 may be an attention weight matrix that includes attention weights. The attention weights may be probability values ranging from 0 to 1.

In the MatMul layer 470, a MatMul operation is performed on the matrix 409 and the value matrix 403. The resulting matrix, i.e., matrix 411 shown in FIG. 4B, may be a single-head matrix, which is an output of the attention block 425. As the MHA layer 400 has h attention blocks, there can be h single-head output matrices. The single-head output matrices are concatenated in the concatenation layer 480 to form a concatenated matrix. In the linear layer 490, an MatMul operation is performed on the concatenated matrix and an output weight matrix

$${W}^{O} ∈ {ℝ}^{{hd}_{v} \times {d}_{model}} ,$$

resulting in an output 406 of the MHA layer 400. In some embodiments, the MHA may be denoted as Multihead(Q, K, V)=Concat(head₁, head₂, . . . , headₕ)W^{O}, where Concat denotes concatenation.

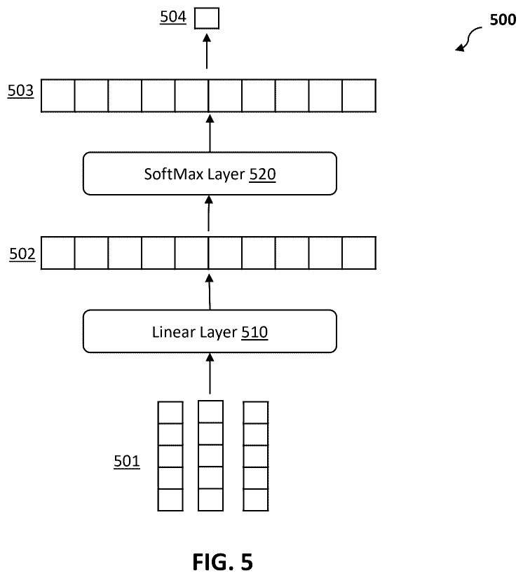

FIG. 5 illustrates an example linear classifier 500, in accordance with various embodiments. The linear classifier 500 may be used in transformer models. In some embodiments, the linear classifier 500 may generate tokens based on outputs of decoders. The linear classifier 500 may be an example of the linear block 130 in FIG. 1. As shown in FIG. 5, the linear classifier 500 includes a linear layer 510 and a SoftMax layer 520. In other embodiments, the linear classifier 500 may include fewer, more, or different components.

The linear layer 510 is provided with a matrix 501. The matrix 501 may be an output of a decoder, e.g., the decoder block 120. A linear transformation may be performed on the matrix 501 and a weight matrix in the linear layer 510. The weight matrix may include weights, which are internal parameters of the linear layer 510. The linear layer outputs a vector 502. In some embodiments, the dimension of the vector 502 (e.g., the total number of elements in the vector 502) may be equal to the total number of classes associated with the AI task being performed by the transformer model. The vector 502 is provided to the SoftMax layer 520. The SoftMax layer 520 generates a vector 503 from the vector 502. In some embodiments, the dimension of the vector 503 may equal the dimension of the vector 502. Each element in the vector 503 may correspond to a predicted token and may indicate a probability score of the predicted token. The probability score may indicate the probability that the prediction is correct. A predicted token 504 having the highest probability score may be selected and output from the linear classifier 500.

The output of the linear classifier 500 may be the output of the transformer model. The execution of the linear classifier 500 may be performed multiple times during inference of the transformer model. For instance, the transformer model may have multiple inference stages, and the linear classifier 500 may be executed at least once in each inference stage. The dimensions of the vectors and matrices shown in FIGS. 2-5 are example dimensions used for purpose of illustration and simplicity. Any of the vectors and matrices used or computed by operations illustrated in FIGS. 2-5 may have different dimensions.

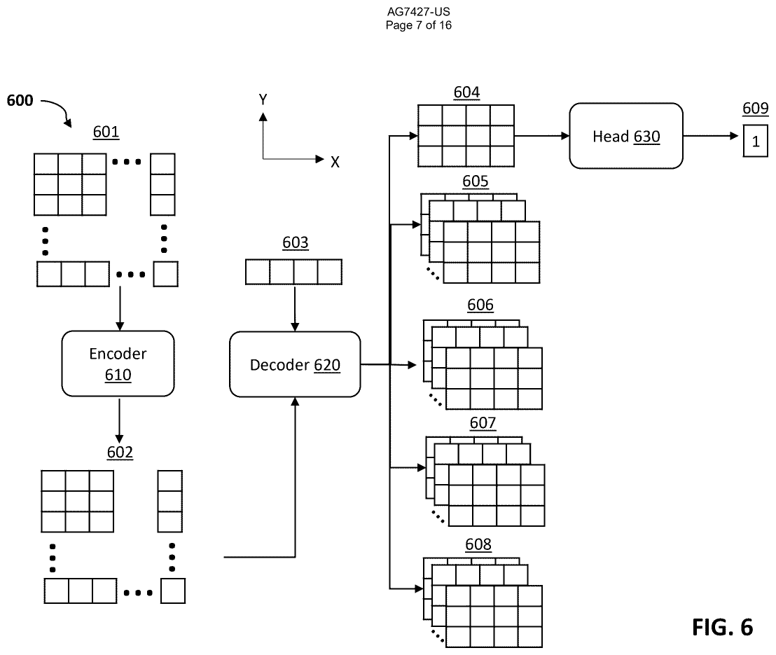

FIG. 6 illustrates a first inference stage of a transformer model 600, in accordance with various embodiments. The transformer model 600 includes an encoder 610, a decoder 620, and a head 630. An example of the transformer model 600 may be the transformer model 100 in FIG. 1. In the embodiments of FIG. 6, the encoder 610 receives an input tensor 601. The input tensor 601 may be a feature map extracted from one or more images, text documents, audio files, videos, other types of data, or some combination thereof. In some embodiments, the input tensor 601 may be generated by another neural network, e.g., a CNN. The encoder 610 generates an output tensor 602 from the input tensor 601. The shape of the output tensor 602 may be denoted as [batch size, SL_{encoder}, d_{model}], where SL_{encoder} may be the dimension along the X axis (i.e., the width of the output tensor 602), and d_{model} may be the dimension along the Y axis (i.e., the height of the output tensor 602). The encoder 610 may include a plurality of layers arranged in a sequence, such as the layers inside the encoder block 110 in FIG. 1. The output tensor 602 is provided to the decoder 620.

The decoder 620 receives the output tensor 602 and an input sequence 603. The input sequence 603 may be a sequence of tokens. A token may be a numerical representation of an input signal, such as word, image, audio signal, video signal, etc. The dimension of the input sequence 603, which may be denoted as SLᵢₙₚᵤₜ, may be the total number of tokens in the input sequence 603. For the purpose of illustration and simplicity, SLᵢₙₚᵤₜ is 4. In other embodiments, the input sequence 603 may have a different shape. For instance, the input sequence 603 may be a 2D tensor. The dimension of the 2D tensor along the X axis may be SLᵢₙₚᵤₜ, while the dimension of the 2D tensor along the Y axis may be a batch size indicating the number of batches in the input sequence 603.

The decoder 620 computes an output tensor 604, a self-attention key tensor 605, a self-attention value tensor 606, a cross-attention key tensor 607, and a cross-attention value tensor 608. In some embodiments, the shape of the output tensor 604 may be denoted as [batch size, SLᵢₙₚᵤₜ, d_{model}]. The shape of the self-attention key tensor 605 or the shape of the self-attention value tensor 606 may be denoted as N×[batch size, h, SLᵢₙₚᵤₜ, d_{read}], where N is the number of identical layers in the decoder (e.g., the number of layers 150 in the decoder block 120), h is the total number of heads in a MHA layer, and d_{head} is the dimension of a query vector, key vector, or value vector. In some embodiments, d_{model}=h×d_{head}. The shape of the cross-attention key tensor 607 or the shape of the cross-attention value tensor 608 may be denoted as N×[batch size, h, SL_{encoder}, dead].

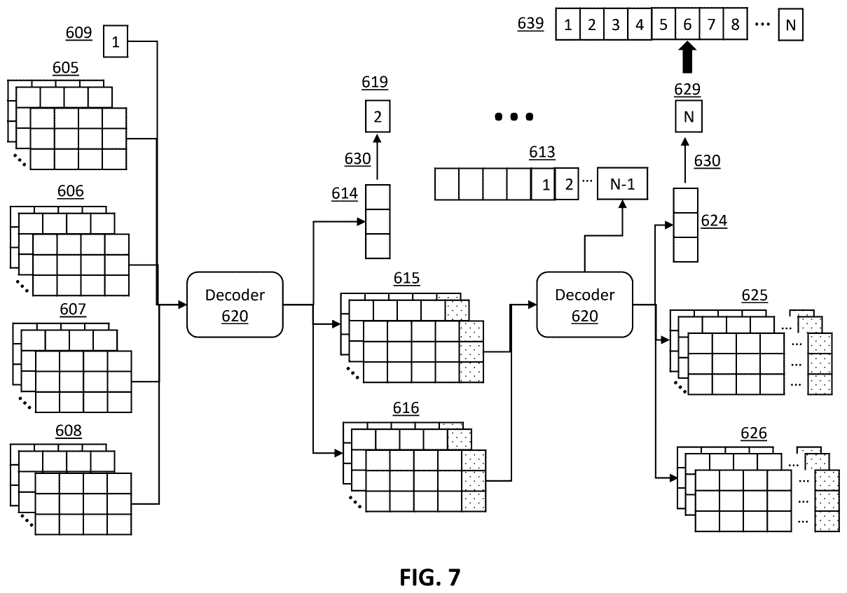

The output tensor 604 may be provided to the head 630 and the head 630 outputs a predicted token 609. The shape of the token 609 may be denoted as [batch size, 1]. For the purpose of illustration and simplicity, batch size is 1 in FIG. 6. In other embodiments, batch size may be a larger number. The predicted token 609 may be stored in a buffer. In some embodiments, the predicted token 609 may be used to update the input sequence 603. For instance, the predicted token 609 may be added to the right of the input sequence 603. The updated input sequence may be used as the input sequence in the second inference stage. In the second inference stage, the decoder 620 may receive the updated input sequence and the output tensor 602 for predicting another token. The output tensor 602 may remain the same during inference of the decoder 620. Certain aspects of subsequent inference stages are described below in conjunction with FIG. 7.

In some embodiments, the self-attention key tensor 605 and the self-attention value tensor 606 may be provided to a self-attention layer in the decoder 620, an example of such a self-attention layer is the MHA layer 151. The self-attention key tensor 605 may be stored in a self-attention key cache. The self-attention key cache may have the same shape as the self-attention key tensor 605. The self-attention value tensor 606 may be stored in a self-attention value cache. The self-attention value cache may have the same shape as the self-attention value tensor 606.

In some embodiments, the decoder 620 computes the self-attention key tensor 605 and the self-attention value tensor 606 from the input sequence 603. The input sequence 603 may be dynamic during inference of the decoder 620. For instance, a new token may be added to the input sequence 603 after each inference stage, as described above. As the input sequence 603 changes, the self-attention key tensor 605 and the self-attention value tensor 606 would also change. For instance, the dimension of the self-attention key tensor 605 or the self-attention value tensor 606 along the X axis may increase as SLᵢₙₚᵤₜ increases. The self-attention key cache and the self-attention value cache may change during all the inference stages of the decoder 620 to accommodate the changes in the self-attention key tensor 605 and the self-attention value tensor 606.

In some embodiments, the cross-attention key tensor 607 and the cross-attention value tensor 606 may be provided to a cross-attention layer in the decoder 620, an example of such a cross-attention layer is the MHA layer 153. The cross-attention key tensor 607 may be stored in a cross-attention key cache. The cross-attention key cache may have the same shape as the cross-attention key tensor 607. The cross-attention value tensor 608 may be stored in a cross-attention value cache. The cross-attention value cache may have the same shape as the cross-attention value tensor 608. In some embodiments, the decoder 620 computes the cross-attention key tensor 607 and the cross-attention value tensor 606 from the output tensor 602 generated in the encoder 610. As the output tensor 602 does not change during inference of the decoder 620, the cross-attention key tensor 607 and the cross-attention value tensor 606 may remain the same during all the inference stages of the decoder 620. The cross-attention key cache and the cross-attention value cache may remain the same during all the inference stages of the decoder 620.

FIG. 7 illustrates subsequent inference stages of the transformer model, in accordance with various embodiments. In the second inference stage, the decoder 620 may reuse the self-attention key tensor 605, self-attention value tensor 606, cross-attention key tensor 607, and cross-attention value tensor 608. The decoder 620 also receives the predicted token 609. The decoder 620 may compute self-attention key vectors from the predicted token 609 and concatenate the self-attention key vectors with the self-attention key tensor 605 to generate a new self-attention key tensor 615. For instance, a self-attention key vector for each head may be added to the right of a self-attention key matrix in the self-attention key tensor 605, and the self-attention key vector and the self-attention key matrix may correspond to the same head. The elements highlighted with a dot pattern in the self-attention key tensor 615 are the self-attention key vectors generated from the predicted token 609.

Similarly, the decoder 620 may compute self-attention value vectors from the predicted token 609 and concatenate the self-attention value vectors with the self-attention value tensor 606 to generate a new self-attention value tensor 616. For instance, a self-attention value vector for each head may be added to the right of a self-attention value matrix in the self-attention value tensor 606, and the self-attention value vector and the self-attention value matrix may correspond to the same head. The elements highlighted with a dot pattern in the self-attention value tensor 616 are the self-attention value vectors generated from the predicted token 609.

The decoder 620 also generates an output tensor 614. The decoder 620 may generate the output tensor 614 using the new self-attention key tensor 615 and new self-attention value tensor 616. The output tensor 614 is used by the head 630 to generate another predicted token 619. The predicted token 619 is the output of the transformer model 600 in the second inference stage.

One or more other subsequent inference stages may be conducted. In each subsequent inference stage, the decoder 620 receives a token predicted in the previous inference stage, a self-attention key tensor generated in the previous inference stage, a self-attention value tensor generated in the previous inference stage, the cross-attention key tensor 607, and the cross-attention value tensor 608. The decoder 620 may, in the subsequent inference stage, generate a larger self-attention key tensor and a larger self-attention value tensor, in addition to an output tensor which can be used by the head 630 to predict a new token.

In embodiments where the total number of inference stages is N, the input sequence 603 is updated to an input sequence 613 after N−1 inference stages. In the last inference stage (i.e., the Nth inference stage), the decoder 620 may receive the predicted token generated in the (N−1)th inference stage, the self-attention key tensor generated in the (N−1)th inference stage, the self-attention value tensor generated in the (N−1)th inference stage, the cross-attention key tensor 607, and the cross-attention value tensor 608. The decoder 620 may generate a self-attention key tensor 625 and a self-attention value tensor 626 using the predicted token generated in the (N−1)th inference stage, the self-attention key tensor generated in the (N−1)th inference stage, and the self-attention value tensor generated in the (N−1)th inference stage. The dimensions of the self-attention key tensor 625 or self-attention value tensor 626 along the X axis is SLᵢₙₚᵤₜ+N. The decoder 620 also generates an output tensor 624, which is used by the head 630 to generate the last predicted token 629. The N tokens predicted by the transformer model in the N inference stages may constitute an output tensor 639, which may be the final output of the transformer model.

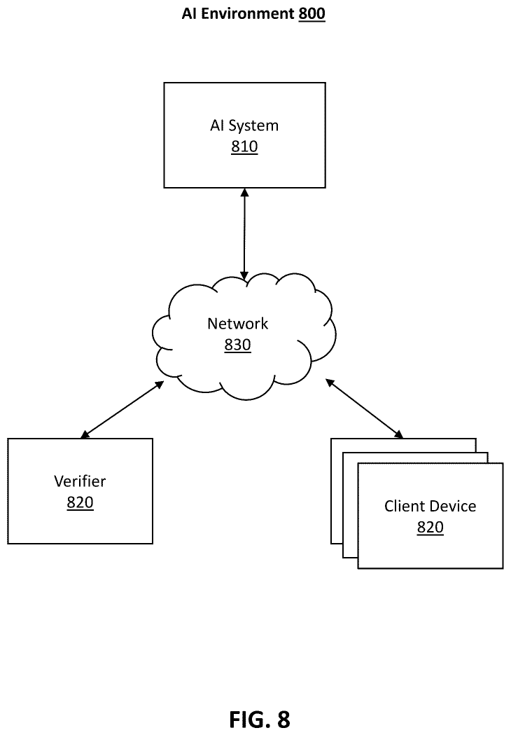

FIG. 8 illustrates an AI environment 800, in accordance with various embodiments. The AI environment 800 includes an AI system 810, a plurality of client devices 830 (individually referred to as client device 830), and a verifier 820. The AI system 810, client devices 830, and verifier 820 are connected through a network 840. In other embodiments, alternative configurations, different or additional components may be included in the AI environment 800. For example, the AI environment 800 may include multiple AI servers or verifiers. Further, functionality attributed to a component of the AI environment 800 may be accomplished by a different component included in the AI environment 800 or a different system. For instance, functionality attributed to the client device 830 may be accomplished by the AI system 810 or client devices 830.

The AI system 810 manages a platform that provides access to AI models. The platform may also provide tools through APIs, SDKs, and integrated services. Users may access the platform by using the client device 830. Users can obtain AI assistance and build applications powered by transformer models without managing the models themselves. The AI system 810 may include various types of processing units, including central processing unit (CPU), graphics processing unit (GUP), AI accelerator, and so on. The AI system 810 may also function as a prove that can prove correctness of transformer model inference, including inference done for deploying transformer models to perform AI tasks.

In some embodiments, the AI system 810 generates and deploys DNNs, including transformer models, such as large language models. The AI system 810 may design and train transformer models. In some embodiments, the AI system 810 uses massive datasets to train transformer models. A trained transformer model may include a large number of internal parameters, such as millions or billions of weights. The transformer models may predict and generate text, images, videos, audios, or other types of data based on input prompts, enabling tasks like conversational AI, text summarization and translation, code generation, creative writing, content creation, and so on.

The AI system 810 may provide and manage APIs for users to access transformer models, including trained transformer models. The AI system 810 may also provide and manage a platform through which users can access consumer-facing products for AI assistance. The AI system 810 may host transformer models in the cloud, and users may interact with the transformer models via endpoint. Users may use the client device 830 to access AI products provided by the AI system 810. For instance, users may use the client device 830 to send AI job requests to the AI system 810. An AI job request may include an input prompt.

The AI system 810 may process AI job requests, schedule the AI job, and deploy a transformer model to perform the AI job. In some embodiments, the AI system 810 may input the prompt provided by the user into the transformer model. In other embodiments, the AI system 810 may generate an input from the prompt provided by the user and use the generated input to deploy the transformer model. The AI system 810 may run one or more inference processes of the transformer model. An inference process may include executing the entire transformer model once using the input. The final output of the transformer model may be provided to the user as a response to the user's request.

The AI system 810 may choose not to reveal architecture or internal parameters (e.g., weights) of transformer models. This can ensure performance, security, and compliance. The AI system 810 may receive requests from verifiers to verify and prove that transformer model inference was done correctly. The AI system 810 may support ZKP protocols to verify transformer model inference without exposing model parameters, input data, or other types of proprietary details. ZKP can verify correctness without leaking data or model details to protect privacy. It can also ensure outsourced or third-party computations are genuine and compliant to build trust. ZKP can be important for applications involving sensitive data, such as AI applications related to healthcare, finance, and so on.

In some embodiments, when or after a transformer model predicts an output from an input, the AI system 810 may generate ZKP that can prove the prediction was computed by the correct model without revealing the model weights. The AI system 810 may leverage gauge symmetry in attention mechanisms of transformer models to generate ZKP. The AI system 810 may generate two types of proofs. For instance, the AI system 810 may generate PoGE from the actual weights of the deployed transformer model through gauge transformation. The AI system 810 may also generate PoVI by executing the canonical version of the transformer model. In some embodiments, the AI system 810 may generate PoGE once per deployment and may generate PoVI once per inference.

The verifier 820 requests verification of transformer model inference. The verifier 820 may be a system controlled by clients, end users, on-chain smart contracts, and so on. The verifier 820 may generate requests to confirm the correctness of an AI's model's computation before, when, or after an AI model is deployed to perform an AI task. The verifier 820 may send the requests to the AI system 810. In some embodiments, the verifier 820 may be an application running on the client devices 830. The verifier 820 may provide a user interface (e.g., a graphical user interface) that allows a user, who makes a request for transformer model inference, to also make a request to verify the transformer model inference. In other embodiments, the verifier 820 is a third-party system.

The verifier 820 may use a randomized verification protocols to make requests for verifying transformer model inference. The randomized verification protocols may employ Fiat-Shamir transformations to generate challenge vectors non-interactively, enabling the verifier 820 to maintain zero-knowledge properties without trusted setup requirements. For instance, the Fiat-Shamir transformation converts interactive, randomized verification protocols into non-interactive ones by replacing random challenges of the verifier 820 with a hash function instead of having the verifier 820 send a random challenge value to the prover (e.g., the AI system 810), the prover can compute this value by using a random function, such as a cryptographic hash function. With a non-interactive verification protocol, the AI system 810 may generate challenges itself. A challenge may include a random input, e.g., one or more random vectors. The random vectors may be embedding vectors. The AI system 810 may use the random input to generate a response. The response may include an entire proof, such as PoGE and PoVI. The verifier 820 may receive the proof without any interaction with the AI system 810. The verifier 820 may use the response to check whether the computations in the transformer model inference were correct. In some embodiments, the verifier 820 may be convinced that the transformer model inference was correct in response to correct execution of the Fiat-Shamir protocol.

In some embodiments, the verifier 820 may receive two types of proofs from the AI system 810, such as PoGE and PoVI, as a response to a random challenge. PoGE may include canonical weights of a transformer model, which is a variance of the deployed weights, meaning the weights used for the actual transformer model inference for performing the AI tasks requested by the user. The client device 830 may check equivalence between the canonical weights and the deployed weights based on public reference. The PoGE may establish that the deployed weights are functionally identical to the canonical weights through gauge transformation. The PoGE may demonstrate knowledge of transformation matrices without revealing them. PoVI may include an inference of the canonical version of the transformer model (“canonical model”). The canonical model may have the same layers as the deployed model but the weights of the canonical model are the canonical weights in lieu of the deployed weights. In some embodiments, the PoVI includes an output of the canonical model, which may be generated from the same input used for the deployment. The verifier 820 may verify, using the PoVI, that the model output follows correctly from the input.

The client devices 830 delegates AI tasks to AI service providers, e.g., the AI system 810. A client device 830 may provide a user interface (e.g., a graphical user interface) that allows the user to make AI task requests, e.g., a request for transformer model inference. The user interface may allow the user to enter a prompt. The client device 830 may generate an AI task request from the prompt and send the AI tasks request to the AI system 810. The user interface may also allow the user to see the status of the AI task. For instance, the user interface may provide for display to the user how much of the inference has been done. The user interface may also provide for display to the user the output of the transformer model after it is received from the AI system 810.

A client device 830 may be one or more computing devices capable of receiving user input as well as transmitting and/or receiving data via the network 840. In one embodiment, a client device 830 is a conventional computer system, such as a desktop or a laptop computer. Alternatively, a client device 830 may be a device having computer functionality, such as a personal digital assistant (PDA), a mobile telephone, a smartphone, an autonomous vehicle, or another suitable device. A client device 830 is configured to communicate via the network 840. In one embodiment, a client device 830 executes an application allowing a user of the client device 830 to interact with the AI system 810 (e.g., the distributer 860 of the AI system 810). The client device 830 may request DNNs or send feedback to the distributer 860 through the application. For example, a client device 830 executes a browser application to enable interaction between the client device 830 and the AI system 810 via the network 840. In another embodiment, a client device 830 interacts with the AI system 810 through an application programming interface (API) running on a native operating system of the client device 830, such as IOS® or ANDROID™.

In an embodiment, a client device 830 is an integrated computing device that operates as a standalone network-enabled device. For example, the client device 830 includes display, speakers, microphone, camera, and input device. In another embodiment, a client device 830 is a computing device for coupling to an external media device such as a television or other external display and/or audio output system. In this embodiment, the client device 830 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 830 may be configured to be compatible with a generic external media device that does not have specialized software, firmware, or hardware specifically for interacting with the client device 830.

The network 840 supports communications between the AI system 810, verifier 820, and client devices 830. The network 840 may comprise any combination of local area and/or wide area networks, using both wired and/or wireless communication systems. In one embodiment, the network 840 may use standard communications technologies and/or protocols. For example, the network 840 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 840 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 840 may be represented using any suitable format, such as hypertext markup language (HTML) or extensible markup language (XML). In some embodiments, all or some of the communication links of the network 840 may be encrypted using any suitable technique or techniques.

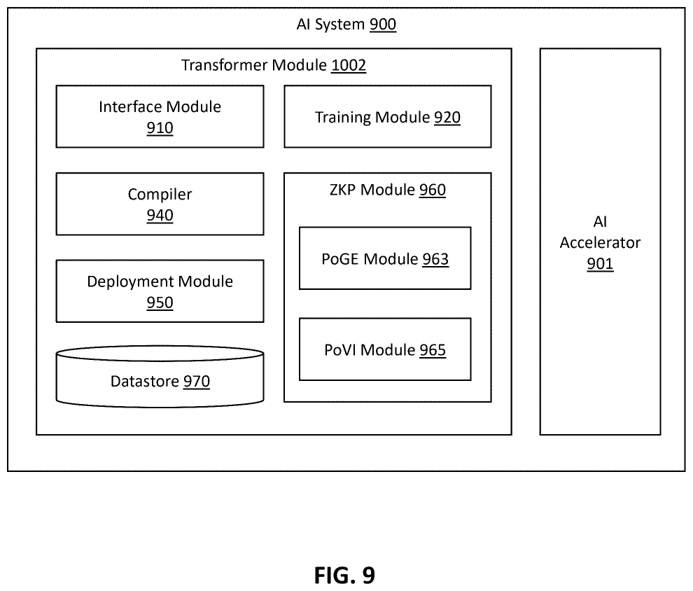

FIG. 9 is a block diagram of an AI system 900, in accordance with various embodiments. The AI system 900 can generate and deploy transformer-based models, such as the transformer models described above. The AI system 900 may also verify transformer model inference using proofs with a two-tier architecture. The AI system 900 may be an example of the AI system 810 in FIG. 8. As shown in FIG. 9, the AI system 900 includes an AI accelerator 901 and a transformer module 902. In other embodiments, alternative configurations, different or additional components may be included in the AI system 900. For example, the AI system 900 may include multiple AI accelerators or transformer modules. As another example, the AI system 900 may include one or more GPUs, central processing units, etc. Further, functionality attributed to a component of the AI system 900 may be accomplished by a different component included in the AI system 900 or a different system. For instance, functionality attributed to the transformer module 902 may be accomplished by the AI accelerator 901, or vice versa. In some embodiments, the transformer module 902 may be implemented in a processing unit that is separate from AI accelerator 901. For instance, the transformer module 902 may be implemented by one or more CPUs. The AI accelerator 901 may also be referred to as a neural processing unit, DNN accelerator, or AI processor.

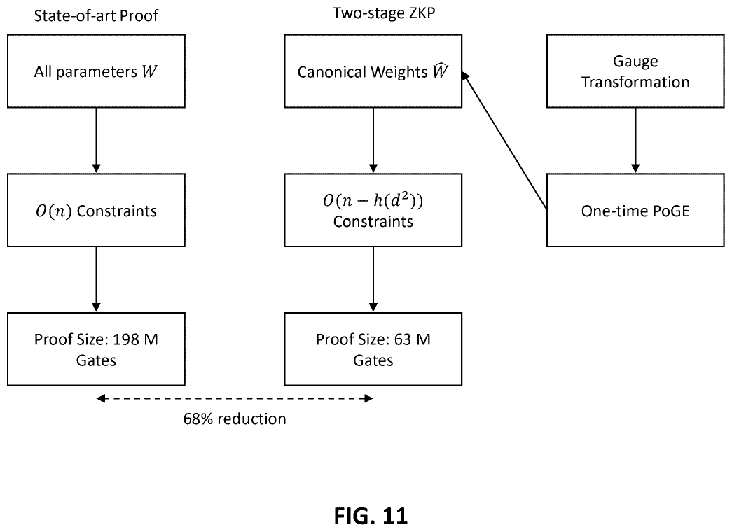

The AI accelerator 901 may be a hardware device that can execute transformer models. For instance, the AI accelerator 901 can execute a transformer model by carrying out neural network operations in the transformer model. The process of carrying out a neural network operation is also referred to as a process of executing the neural network operation or a process of performing the neural network operation. A neural network operation may be a layer (or a sublayer within a layer) of the transformer model. Examples of neural network operations include embedding operations, MatMul operation, additions, activation functions, and so on. The execution of the transformer model may be for training the transformer model or for deploying the transformer model to perform AI tasks. The AI accelerator 901 may include data storage units and compute units. The data storage units, such as dynamic random-access memory (DRAM), SRAM, etc., may store data processed or generated by the compute units. The compute units may perform computations in neural network operations of transformer models. The data storage units may implement one or more look-up tables or KV cache for transformer model execution. A compute unit may include one or more multipliers, accumulators, shifters, other types of hardware components, or some combination thereof. Certain aspects regarding AI accelerator are described below in conjunction with FIG. 11.

The transformer module 902 generates transformer models. In some embodiments, the transformer module 902 may define the architecture of a transformer model and determine values of internal parameters (e.g., weights) of the model through one or roe training processes. The transformer module 902 may also compress transformer models during or after training. For instance, the transformer module 902 may canonicalize transformer models based on gauge transformation or compress KV cache of transformer models. The transformer module 902 may further determine one or more hyperparameters that define how the transformer model is trained, compressed, or executed. Examples of hyperparameters may include training hyperparameters (e.g., batches, epochs, etc.), gauge transformation matrices for canonicalization, sliding window size for hot window cache, rank-r for KV caching, and so on. The transformer module 902 may further compile transformer models (e.g., trained or compressed transformer models) to generate models executable by the AI accelerator 901. In some embodiments, the transformer module 902 may function as the host for transformer model inference. The transformer module 902 may facilitate cached inference of the transformer model, in which keys and values of attention layers may be cached and reused during the inference of the transformer model. The inference for making the prediction may include a sequence of inference stages, which generates a sequence of predicted tokens. The sequence of predicted tokens may be the prediction of the transformer model. The transformer module 902 may also facilitate ZKP execution to verify correctness of transformer model inference without disclosing proprietary details of transformer models.

As shown in FIG. 9, the transformer module 902 includes an interface module 910, a training module 920, a compiler 940, a deployment module 950, a ZKP module 960, and a datastore 970. In other embodiments, alternative configurations, different or additional components may be included in the transformer module 902. Further, functionality attributed to a component of the transformer module 902 may be accomplished by a different component included in the transformer module 902 or a different module or system.

The interface module 910 facilitates communications of the transformer module 902 with other modules or systems. For example, the interface module 910 establishes communication between the transformer module 902 with an external database to receive data that can be used to train transformer models or requests of deploying transformer models to perform tasks. As another example, the interface module 910 supports transformer model deployment and verification of transformer model inference. The interface module 910 may receive AI task requests, e.g., requests to deploy transformer models to perform AI tasks. The interface module 910 may also send out outputs of transformer models as responses to AI task requests. The interface module 910 may also send out proofs that can verify transformer model inference.

The training module 920 trains transformer models by using training datasets. The training module 920 forms the training dataset. In an example where the training module 920 trains a transformer model to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the transformer model, and the rest of the training dataset may be held back as a validation subset used by the training module 920 to validate performance of a trained transformer model. The portion of the training dataset not including the tuning subset and the validation subset may be used to train the transformer model.

The training module 920 also determines hyperparameters for training the transformer model. Hyperparameters are variables specifying the transformer model training process. Hyperparameters are different from parameters inside the transformer model (e.g., weights of filters). In some embodiments, hyperparameters include variables determining the architecture of the transformer model, such as number of hidden layers, etc. Hyperparameters also include variables which determine how the transformer model is trained, such as batch size, number of epochs, etc. A batch size defines the number of training samples to work through before updating the parameters of the transformer model. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the transformer model. An epoch may include one or more batches. The number of epochs may be 1, 5, 9, 50, 90, 500, 900, or even larger.

The training module 920 defines the architecture of the transformer model, e.g., based on some of the hyperparameters. An example of architectures defined by the training module 920 is the architecture of transformer model 90 shown in FIG. 1. After the training module 920 defines the architecture of the transformer model, the training module 920 may input a training dataset into the transformer model. The training dataset includes a plurality of training samples and ground-truth labels of the training samples. A training sample may be an input (e.g., a sequence of input tokens, etc.) that can be fed into the transformer model. The ground-truth label of the training sample may be a known or verified predictions or decision made using the training sample. The training module 920 may modify the parameters inside the transformer model (“internal parameters of the transformer model”) to minimize the error between labels of the training objects that are generated by the transformer model and the ground-truth labels of the objects. The internal parameters may include weights of filters in the convolutional layers of the transformer model. In some embodiments, the training module 920 uses a cost function to minimize the error.

The training module 920 may train the transformer model for a predetermined number of epochs. The number of epochs is a hyperparameter that defines the number of times that the deep learning algorithm can work through the entire training dataset. One epoch means that each sample in the training dataset has had an opportunity to update internal parameters of the transformer model. After the training module 920 finishes the predetermined number of epochs, the training module 920 may stop updating the parameters in the transformer model. The transformer model having the updated parameters is referred to as a trained transformer model.

The training module 920 may also verify accuracy of trained or compressed transformer models. In some embodiments, the training module 920 inputs samples in a validation dataset into a trained transformer model and uses the outputs of the transformer model to determine the model accuracy. In some embodiments, a validation dataset may be formed of some or all the samples in the training dataset. Additionally or alternatively, the validation dataset includes additional samples, other than those in the training sets. In some embodiments, the training module 920 may determine an accuracy score measuring the precision, recall, or a combination of precision and recall of the transformer model. The training module 920 may use the following metrics to determine the accuracy score: Precision=TP/(TP+FP) and Recall=TP/(TP+FN), where precision may be how many the transformer model correctly predicted (TP or true positives) out of the total it predicted (TP+FP or false positives), and recall may be how many the transformer model correctly predicted (TP) out of the total number of objects that did have the property in question (TP+FN or false negatives). The F-score (F-score=2*PR/(P+R)) unifies precision and recall into a single measure.

The training module 920 may compare the accuracy score with a threshold score. In an example where the training module 920 determines that the accuracy score of the transformer model is less than the threshold score, the training module 920 may re-train the transformer model. In one embodiment, the training module 920 may iteratively re-train the transformer model until the occurrence of a stopping condition, such as the accuracy measurement indication that the transformer model may be sufficiently accurate, or a number of training rounds having taken place.

The compiler 940 compiles transformer models. For instance, the compiler 940 may compile transformer models after they are trained and are ready for deployment. The compiler 940 may generate instructions (e.g., configuration parameters) that can be executed by AI accelerator 901. The transformer module 902 may write the instructions into configuration registers of the AI accelerator 901. Components of the AI accelerator 901 may operate in accordance with the instructions to execute the transformer model. For instance, the compiler 940 may generate instructions that control data transfer (e.g., memory read, memory write, etc.) and computations in the AI accelerator 901. The compiler 940 may compile a transformer model for deployment purpose or verification purpose.

In some embodiments, the compiler 940 may generate a graph representing a transformer model. The graph may include nodes and edges. A node may represent a specific neural network operation in the transformer model. An edge may connect two nodes and represent a connection between the two corresponding neural network operations. In an example, an edge may encode a tensor that flows from one of the neural network operations to the other neural network operation. The tensor may be an output tensor of the first neural network operation and an input tensor of the second neural network operation. The edge may encode one or more attributes of the tensor, such as size, shape, storage format, and so on. The compiler 940 may use the graph to generate instructions (e.g., compilation descriptors). The instructions would be executed by components of the AI accelerator 901 to execute the transformer model.

The deployment module 950 may control and manage transformer model deployment for performing AI. A transformer model deployment may include one or more inference processes, in each of which the transformer model is executed to generate an output from an input. In some embodiments, the deployment module 950 may distribute transformer models to devices or systems which may use the transformer models to perform tasks (e.g., image classification, motion planning, etc.) for which the transformer models were trained. In other embodiments, the deployment module 950 may facilitate deployment of the transformer models using the AI accelerator 901. For instance, the deployment module 950 may receive transformer inference requests. A transformer inference request may be a request to deploy a transformer model to perform an AI task, e.g., language processing task, computer vision task, speech recognition task, and so on. The deployment module 950 may schedule transformer inference jobs based on attributes of the transformer models and attributes of the AI accelerator 901. An AI task may involve executing a transformer model to generate an output based on input data. The weights of the transformer model that are used for generating the output may be referred to as deployed weights.

In some embodiments, the deployment module 950 may start a transformer inference job by sending information regarding the transformer inference to the other components of the transformer module 902. For instance, the deployment module 950 may instruct the training module 920 to train a transformer model that can perform the job. The deployment module 950 may also instruct the compiler 940 to compile a compressed model to generate an executable model. The deployment module 950 may also instruct the transformer module 902 to perform the inference in accordance with the schedule. The information provided by the deployment module 950 may be included in the transformer inference request or generated by the deployment module 950 based on the transformer inference request. For instance, the transformer inference request may indicate an accuracy requirement on the output of the transformer model. The deployment module 950 may determine an accuracy threshold score based on the transformer inference request and instruct the training module 920 to train the transformer model based on the accuracy threshold score.

The ZKP module 960 provides ZKP for proving correctness of transformer model inference without sharing proprietary data. The ZKP module 960 may establish ZKP protocols with gauge symmetry optimization for deployed transformer models. As described above, a transformer model may be deployed to perform AI tasks. The transformer model may have been trained, e.g., by the training module 920, before the deployment. The weights of the model for the deployment are referred to as deployed weights. The deployment of the transformer model includes an inference of the transformer model, which is a process of executing the transformer model to compute an output from an input using the deployed weights. The ZKP module 960 may facilitate generation of verification objects for deployed transformer models to be shared with verifiers. For instance, the ZKP module 960 may provide proof that the input is run on the transformer model to generate the output without revealing the deployed weights. Such proof may be ZKP, which may prove that specific computations using the deployed weights have occurred without revealing the deployed weights.

In some embodiments, the ZKP module 960 may support a two-component proof structure that includes distinct gauge equivalence proofs and inference proofs that reference canonical weight commitments rather than arbitrary parameter commitments. The canonical weight commitments may satisfy specific mathematical properties, namely balanced query-key Gram matrices and orthonormalized value projections. In some embodiments, the ZKP module 960 may generate or verify gauge equivalence proofs separately from inference proofs, either through distinct application programming interface (API) endpoints or configuration parameters.

The ZKP module 960 may generate a one-time PoGE to a canonical model and per-inference proofs (PoVI) on the canonical model. In some embodiments, canonicalization can significantly reduce model-level prover gates/constraints without changing model function. This optimization may be upstream of the prover and can further reduce proof time and memory on smaller circuits. The savings can multiply with parameter tying in grouped-query attention (GQA) or multi-query attention (MQA) and with mixture-of-experts (MoE) sparsity, since PoGE or PoVI scale with the number of distinct parameter blocks rather than the head count. As shown in FIG. 9, the ZKP module 960 includes a PoGE module 963 and a PoVI module 965. In other embodiments, the compression module 930 may include fewer, more, or different components.

The PoGE module 963 generates PoGE for deployed transformer models. In some embodiments, the PoGE module 963 may perform one-time PoGE generation for a particular transformer model. For instance, the PoGE generated by the PoGE module 963 may be valid when the weights of the transformer model remain the same. In some embodiments, the PoGE module 963 may generate PoGE once per model deployment to demonstrate knowledge of transformation matrices without revealing them.

The PoGE module 963 may establish a canonical form for transformer weights (e.g., deployed weights) through a systematic gauge-fixing procedure. The canonical form of the weights may be referred to as canonical weights and can serve as a unique representative within each equivalence class of functionally identical parameters, selected through a deterministic algorithm that balances query-key Gram matrices and orthonormalizes value projections. The PoGE module 963 may convert deployed weights to canonical weights and establish that deployed weights are functionally identical to canonical weights through gauge transformation. In some embodiments, the PoGE module 963 may canonicalize weights of attention layers of a transformer model. For instance, the PoGE module 963 may facilitate a one-time gauge canonicalization and rewrite weights so that the values are orthonormal and queries/keys are scale-balance. The PoGE module 963 may construct a per-head canonical representative that preserves the exact forward map and is efficient certifiable by PoGE.

An attention layer of the transformer model may have a plurality of weight matrices. The weights of these weight matrices may be determined by training the transformer model. The weight matrices may include a query weight matrix W_{Q}, key weight matrix W_{K}, value weight matrix W_{V}, and output weight matrix W_{O}. These weight matrices may also be referred to as projection matrices. The attention layer may receive input embeddings and convert the input embedding into queries, keys, and values using the query weight matrix W_{O}, key weight matrix W_{K}, and value weight matrix W_{V}, respectively. A MatMul operation and SoftMax function may be applied on the queries and values. The resulting matrix of the SoftMax function and the values may go through an MatMul operation, the result of which may be converted to an output matrix of the attention layer using the weight matrix W_{O}.

The attention layer may have h query heads and g K/V heads. In some embodiments (e.g., embodiments where the attention layer is an MHA layer), h=g. In other embodiments (e.g., embodiments where the attention layer is a GQA or MQA layer), h≥g. The per-head weight matrix may be denoted as

$${W}_{Q}^{( i )} , {W}_{K}^{( i )} ∈ {ℝ}^{{d}_{model} \times {d}_{k}} , {W}_{V}^{( i )} ∈ {ℝ}^{{d}_{model} \times {d}_{v}} , and {W}_{O}^{( i )} ∈ {ℝ}^{{d}_{v} \times {d}_{model}} ,$$

where i is the index of the head, d_{q} is the dimension of a query tensor, dₖ is the dimension of a key tensor, dᵥ is the dimension of a value tensor. In some embodiments, d_{q}=dₖ=dᵥ=d_{model}/h. The attention layer may compute queries qₜ, keys kₛ, and values vₛ from hidden states, then mix values using SoftMax-normalized dot-product weights. The dot products of queries and keys may be denoted as

$${q}_{t}^{( i )} {k}_{s}^{( i ) T} .$$

SoftMax weights may be denoted as

$${α}_{t}^{( i )} .$$

Outputs of the attention layer may be denoted as

$${\sum }_{s \leq t} {α}_{t , s}^{( i )} {v}_{s}^{( i )} {W}_{O}^{( i )} .$$

In an example, the input of an attention layer may be a sequence of n token embeddings, which may be denoted as X∈ [symbol] ^{n×d}^{_{model}}. Each attention head i={1, . . . , h} may compute queries

$${Q}_{i} = {XW}_{Q}^{( i )} ∈ {ℝ}^{n \times {d}_{k}} ,$$

keys

$${K}_{i} = {XW}_{K}^{( i )} ∈ {ℝ}^{n \times {d}_{k}} ,$$

and values

$${V}_{i} = {XW}_{V}^{( i )} ∈ {ℝ}^{n \times {d}_{v}}$$

through linear projections. The SoftMax function may act row-wise over tokens. The scaled dot-product attention for head i may be

$${B}_{i} ( X ) = softmax ( \frac{{Q}_{i} {K}_{i}^{T}}{\sqrt{{d}_{k}}} ) {V}_{i} ,$$

where Bᵢ∈ [symbol] ^{n×d}^{ᵥ}. The MHA output may be

$$MHA ( X ) = [ {B}_{1} ( X ) ‖ … ‖ {B}_{H} ( X ) ] {W}_{O} = {\sum }_{i = 1}^{h} {B}_{i} ( X ) {W}_{O , i}$$

with

$${W}_{O}^{( i )} ∈ {ℝ}^{{d}_{v} \times {d}_{model}}$$

partitioned into blocks

$${W}_{O , i}^{( i )} ∈ {ℝ}^{{d}_{v} \times {d}_{model}} .$$

An example of transformer attention layers is the MHA layer 400 in FIG. 4A.

The PoGE module 963 may canonicalize the weight matrices through a one-time transformation of the weight matrices. The PoGE module 963 may determine two invertible matrices for each head: a first matrix A for the query-key space and a second matrix C for the value space. The PoGE module 963 may facilitate a gauge transformation in which queries are multiplied by A (i.e., Ŵ_{Q}=W_{Q}A), keys by inverse transpose of A (i.e., Ŵ_{K}=W_{K}A^{-T}), values by C, and output projections by C⁻¹. This transformation may preserve all dot products between queries and keys, maintaining attention weights unchanged, while the second matrix and inverse of the second matrix operations may cancel in the value path, preserving the final output.

The PoGE module 963 may make specific choice of these transformation matrices. For the value space, the PoGE module 963 may perform QR decomposition on the original value projection matrix W_{V} to obtain orthonormal columns Q_{V} and upper triangular R_{V}. QR decomposition, which may also be referred to as QR factorization or QU factorization, may be a decomposition of a matrix into a product QR of an orthonormal matrix Q and an upper triangular matrix R. The QR decomposition may be denoted as QR(W_{V})=Q_{V}R_{V}. The PoGE module 963 may set

$$C = {R}_{V}^{- 1} ,$$

which may transform the value projection matrix to Q_{V}. The transformation of the value projection matrix may be denoted as Ŵ_{V}=Q_{V}. Q_{V} may orthonormal columns. This orthonormalization may concentrate energy into the leading coordinates, making the values amenable to both lossless compression through entropy coding and lossy compression through rank truncation with bounded error.

For the query-key space, the PoGE module 963 may compute the geometric mean of the query and key Gram matrices:

$${S}_{Q} = {W}_{Q}^{T} {W}_{Q} and {S}_{K} = {W}_{K}^{T} {W}_{K} .$$

A Gram matrix may be a symmetric matrix where each entry is an inner product of pairs of vectors from a given set. This geometric mean may represent the unique positive definite matrix that simultaneously and balances the scales of queries and keys. The PoGE module 963 may define

$$M = {S}_{Q}^{1 / 2} {S}_{K} {S}_{Q}^{1 / 2}$$

and set

$$A = {S}_{Q}^{- 1 / 2} {M}^{1 / 4} {S}_{Q}^{- 1 / 4} .$$

This may yield A^{T}S_{Q}A=A⁻¹S_{K}A^{-T}=S_{Q} #S_{K} (the matrix geometric mean). In some embodiments, the PoGE module 963 may compute S_{Q} and S_{K} in FP32. In some embodiments, the PoGE module 963 may find matrix G that satisfies GS_{Q}⁻¹G=S_{K}. The solution is given by the matrix geometric mean

$$G = {{S}_{Q}^{1 / 2} ( {S}_{Q}^{- 1 / 2} {S}_{K} {S}_{Q}^{- 1 / 2} )}^{1 / 2} {S}_{Q}^{1 / 2} .$$

The PoGE module 963 may form the geometric mean with FP32 accumulation. The transformation matrix

$$A = {S}_{Q}^{- 1 / 2} {G}^{1 / 2} ,$$

where G=S_{Q}#S_{K}. This balancing operation can equalize the dynamic range across dimensions, improving compressibility particularly for models using ROPE

In an example, for a head i of the attention layer, the PoGE module 963 may determine a transformation matrix Aᵢ∈GL(dₖ) for the query-key space and a transformation matrix Cᵢ∈GL(dᵥ) for the value space. The PoGE module 963 may determine Aᵢ and Cᵢ such as

$${W}_{V}^{( i )} {C}_{i} T$$

has orthonormal columns and

$${W}_{Q}^{( i )} {A}_{i} , {W}_{K}^{( i )} {A}_{i}^{- T}$$

are scale balanced, i.e.,

$${A}_{i}^{T} {S}_{Q} {A}_{i} = {A}_{i}^{- 1} {S}_{K} {A}_{i}^{- T} .$$

The PoGE module 963 may compute

$${QRW}_{V}^{( i )} = {Q}_{V}^{( i )} {R}_{V}^{( i )}$$

and set

$${C}_{i} = {( {R}_{V}^{( i )} )}^{- 1} .$$

In some embodiments, the PoGE module 963 may also transform the weight matrices of the head using the transformation matrices, such as using the transformation matrix Aᵢ∈GL(dₖ) for the query-key space and using the transformation matrix Cᵢ∈GL(dᵥ) for the value space. The PoGE module 963 may use the transformation matrix Aᵢ to canonicalize

$${W}_{Q}^{( i )} and {W}_{K}^{( i )} .$$

The PoGE module 963 may use the transformation matrix Cᵢ to canonicalize

$${W}_{V}^{( i )} and {W}_{O}^{( i )} .$$

In an example, the weight canonicalization may be denoted as:

$${W}_{Q}^{( i )} , {W}_{K}^{( i )} ↦ {W}_{Q}^{( i )} {A}_{i} , {W}_{K}^{( i )} {A}_{i}^{- T} and {W}_{V}^{( i )} , {W}_{O}^{( i )} ↦ {W}_{V}^{( i )} {C}_{i} , {C}_{i}^{- 1} {W}_{O}^{( i )} .$$

The canonical query weight matrix is

$${\hat{W}}_{Q}^{( i )} = {W}_{Q}^{( i )} {A}_{i} .$$

The canonical key weight matrix is

$${\hat{W}}_{K}^{( i )} = {W}_{K}^{( i )} {A}_{i}^{- T} .$$

The canonical value weight matrix is

$${\hat{W}}_{V}^{( i )} \text{=↦} {W}_{V}^{( i )} {C}_{i} .$$

The canonicalized output weight matrix is

$${\hat{W}}_{O}^{( i )} = {C}_{i}^{- 1} {W}_{O}^{( i )} .$$

The PoGE module 963 may perform canonicalization that can lead to orthonormal V and balanced-scale K. The orthonormal V can concentrate energy so delta or residuals can be narrow. The balanced-scale K can reduce plane-wise skew under ROPE, improving shared bit-width decisions. For architectures using ROPE, the PoGE module 963 may include specialized constraints that enforce commutant structure properties. These constraints may operate on 2×2 matrix blocks with specific algebraic relationships that maintain compatibility with position-dependent rotations. Each 2×2 matrix block may be a rotational plane. The presence of these specialized constraints, which verify that aⱼa′ⱼ−bⱼb′ⱼ=1 and aⱼb′ⱼ+bⱼa′ⱼ=0 for each rotational plane, may provide definitive evidence of gauge symmetry exploitation adapted for RoPE architectures. The constraint count in the PoGE module 963 may show a reduction proportional to h(d²ₖ+d²ᵥ) per transformer layer, where h represents the number of attention heads, and dₖ and dᵥ represent key and value dimensions, respectively. Systems using RoPE can show a modified reduction pattern of h(dₖ+d²ᵥ), providing an additional detection signature.

In some embodiments (e.g., embodiments where the transformer model employs RoPE), the PoGE module 963 may respect the block-diagonal structure of the rotation matrices when transforming the weight matrices. For instance, the PoGE module 963 may apply the transformation separately to each 2×2 rotation plane, effectively treating each plane as an independent complex-valued dimension. In some embodiments, the PoGE module 963 may group dₖ coordinates into 2×2 ROPE planes, the commutant may be block-diagonal with blocks

$$( \begin{matrix}{a}_{j} & - {b}_{j} \\ {b}_{j} & {a}_{j}\end{matrix} )$$

(equivalently, complex scaling aⱼ+ibⱼ) per plan, i.e., C_{RoPE}≅(GL(1, [symbol] ))^{d}^{ₖ}^{/2}. The per-layer gauge may become C_{RoPE}=((C_{RoPE})^{h}×(GL(dᵥ)^{h}) [symbol] Sₕ.

In some embodiments, the PoGE module 963 may provide a symmetry-aware verification framework for transformers that can exploit the maximal gauge group of attention. As described above, a transformer model may be converted to a canonical model through gauge transformation. In some embodiments, a canonical model may have a maximal group Gₘₐₓ=((GL(dₖ)^{h})×(GL(dᵥ)^{h})) [symbol] Sₕ. With RoPE, the Q/K action may be reduced to the rotary commutant C_{RoPE}. In some embodiments, the PoGE module 963 may divide dₖ into 2×2 ROPE planes. The PoGE module 963 may also restrict Aᵢ to the commutant: Aᵢ^{(p)}=aₚl+bₚJ. The PoGE module 963 may use scale-only balancing per plane with:

$${A}_{i}^{( p )} = {s}_{p} I , {s}_{p} = {( \frac{det {S}_{K , i}^{( p )}}{det {S}_{Q , i}^{( p )}} )}^{1 / 4} > 0 ,$$

where det may be a function that calculates the determinant of a square matrix. The PoGE module 963 may set

$${A}_{i} = blk diag ( {A}_{i}^{( 1 )} , … , {A}_{i}^{( \frac{{d}_{k}}{2} )} ) ,$$

where blkdiag may be a function that creates a block-diagonal matrix Aᵢ from a list of input matrices

$${A}_{i}^{( 1 )} , … , {A}_{i}^{( \frac{{d}_{k}}{2} )} .$$

The PoGE module 963 may then convert the query weight matrix and key weight matrix based on Aᵢ:

$${W}_{Q}^{( i )} , {W}_{K}^{( i )} ↦ {W}_{Q}^{( i )} {A}_{i} , {W}_{K}^{( i )} {A}_{i}^{- T} .$$

In some embodiments, the PoGE module 963 may also perform head permutation fixing. The PoGE module 963 may define a deterministic per-head signature (row-major over the base field), e.g.,

$${ξ}_{i} = vec ( {W}_{O}^{( i )} ) ‖ vec ( {W}_{V}^{( i )} ) .$$

The PoGE module 963 may reorder heads by increasing ξᵢ (ties by original index). The reordering of the heads may cause the order of the heads of the attention layer in the canonical model different from the order of the heads of the attention layer in the deployed model. The reordering of the heads may be a permutation of the attention layer, which may also be referred to as a permutation of the transformer model.

The PoGE module 963 may generate PoGE from the canonical weights. The PoGE can prove that the canonical weights are functionally the same as the deployed weighs. The attention scores

$${q}_{t}^{( i )} {k}_{s}^{( i ) T}$$

and outputs

$${\sum }_{s \leq t} {α}_{t , s}^{( i )} {v}_{s}^{( i )} {W}_{O}^{( i )}$$

are unchanged by the canonicalization of the weight matrices. The PoGE can also provide that the reindexing of the head, if any, is a pure permutation. The PoGE may provide that the permutation does not impact the correctness of the transformer model inference. The PoGE may be one-time gauge equivalence proof of the transformer model for multiple inference requests, even a large number of inference requites, such as millions. The gauge equivalence proof may be generated during deployment of the t transformer model. The process may require less than ten seconds for models with hundreds of millions of parameters. The proof can potentially be leveraged indefinitely for subsequent inferences. The modular proof architecture can enable flexible deployment patterns that accommodate different operational requirements.

The PoVI module 965 facilitates PoVI operations that verify computing using canonical weights generated by the PoGE module 963. The PoVI module 965 may generate PoVI that operates on the canonical weights. In some embodiments, the PoVI may exclusively operate on the canonical weights, verifying that outputs follow correctly from inputs without redundant parameter constraints. For instance, the PoVI module 965 may facilitate execution of the transformer model using the canonical weights in lieu of the deployed weights. The transformer model with the canonical weights may be referred to as canonical model. The PoVI module 965 may generate a canonical model by replacing the deployed weights of a transformer model with the canonical weights of the transformer model. The PoVI module 965 may instruct the compiler 940 to compile the canonical model. The PoVI module 965 may also instruct the AI accelerator 901 to execute the canonical model. For instance, the AI accelerator 901 may facilitate execution of attention layers using the canonical weight matrices, in lieu of the deployed weight matrices. An attention layer modified with the canonical weight may be referred to as a canonical attention layer or a gauge invariance of the attention layer.

The PoVI module 965 may obtain canonical model inputs for PoVI generation. In some embodiments, the PoVI module 965 may receive an input from a verifier, e.g., the verifier 820 in FIG. 8. The PoVI module 965 may initiate the execution of the canonical model by feeding the received input into the canonical model. The PoVI module 965 may receive a particular input for each PoVI generation. In other embodiments, the PoVI module 965 may generate random inputs for PoVI generation. For instance, the PoVI module 965 may generate random vectors through Fiat-Shamir challenges. The PoVI module 965 may exploit the algebraic structure of gauge transformations to minimize verification complexity. Instead of verifying full matrix multiplications with cubic complexity, the PoVI module 965 may employ randomized linear combination checks that reduce verification to linear complexity while maintaining cryptographic soundness. The PoVI module 965 may verify that transformed matrices satisfy required relationships when projected onto these random subspaces.

An input may be processed in the layers of the canonical model. A verified output may be generated by the canonical model. The verified output may be bit-identical to the output generated by the transformer model using the deployed weights. In some embodiments, the canonical model has the same layer as the deployed transformer model. The execution order of the layers may also be the same. An attention layer may be permuted, e.g., by reordering the heads of the attention layer. The permutation may not impact that the output of the canonical model would be bit-identify to the output of the transformer model for the same input.

In some embodiments, the attention mechanism may operate through two independent computational pipelines that each have internal degrees of freedom. The attention scores may depend on the bilinear form QK^{T}=XW_{Q}(W_{K})^{T}X^{T}. Any transformation that preserves this product can leave the attention scores unchanged. The value transformation depends on the composed mapping VW_{O}=XW_{V}W_{O}. Transforming (W_{Q}, W_{K}) [symbol] (W_{Q}A, W_{K}(A⁻¹)^{T}) can preserve the query-key product, while (W_{V}, W_{O}) [symbol] ((W_{V}C, C⁻¹W_{O}) can preserve the value-output composition, any invertible matrices A and C of approximate dimensions.

In some embodiments, the gauge invariance of attention (“canonical attention”) may be denoted as

$$\begin{matrix}{\hat{q}}_{t}^{( i )} = {x}_{t}^{T} {\hat{W}}_{Q}^{( i )} = {x}_{t}^{T} {W}_{Q}^{( i )} {A}_{i} , {\hat{k}}_{s}^{( i )} = {x}_{s}^{T} {\hat{W}}_{K}^{( i )} = {x}_{s}^{T} {W}_{K}^{( i )} {A}_{i}^{- T} , \\ {\hat{v}}_{s}^{( i )} = {x}_{s}^{T} {\hat{W}}_{V}^{( i )} = {x}_{s}^{T} {W}_{V}^{( i )} {C}_{i} .\end{matrix}$$

The row-SoftMax at temperature τ may be denoted as

$${α}_{t}^{( i )} .$$

With the canonicalize weights, dot products

$${q}_{t}^{( i )} {k}_{s}^{( i ) T} ,$$

weights

$${α}_{t}^{( i )} ,$$

and outputs

$${\sum }_{s \leq t} {α}_{t , s}^{( i )} {v}_{s}^{( i )} {W}_{O}^{( i )}$$

may remain unchanged, meaning

$${\hat{q}}_{t}^{( i )} {\hat{k}}_{s}^{( i ) T} = {q}_{t}^{( i )} {k}_{s}^{( i ) T} , {\hat{α}}_{t}^{( i )} = {α}_{t}^{( i )} , and {\sum }_{s \leq t} {\hat{α}}_{t , s}^{( i )} {\hat{v}}_{s}^{( i )} {\hat{W}}_{O}^{( i )} = {\sum }_{s \leq t} {α}_{t , s}^{( i )} {v}_{s}^{( i )} {W}_{O}^{( i )} .$$

When the per-head outputs of the attention layer are unchanged, the block hidden state hₜ is also unchanged.

In some embodiments, PoVI generation may require substantially less memory compared to the generation of the initial gauge equivalence proofs. There can be reduction in memory consumption, which may stem from the elimination of redundant parameter constraints. For instance, KV cache for the canonical model may be smaller than KV cache for the deployed model. Due to the simplified constraint structure, the memory access patterns may be more sequential. Gauge optimization can be combined with other frameworks to gain further performance improvements. In some embodiments, the ZKP module 960 may generate witnesses that include explicit gauge transformation matrices during the equivalence proof phase but exclude these transformations during inference proofs. In some embodiments, the proving time for model verification may have a bimodal distribution, with an initial longer proof generation for gauge equivalence followed by consistently faster inference proofs. The ZKP module 960 may also detect and diagnose error types related to gauge equivalence verification failures, canonical form mismatches, or transformation matrix invertibility issues.

The datastore 970 stores data received, generated, used, or otherwise associated with the transformer module 902. For example, the datastore 970 stores training datasets used by the training module 920 to train transformer models. The datastore 970 may also store data generated by the training module 920, such as the hyperparameters for training DNNs, internal parameters of trained DNNs (e.g., weights, etc.), data for sparsity acceleration (e.g., sparsity bitmap, etc.), and so on. The datastore 970 may also store graphs, configuration parameters, instructions, or other data generated by the compiler 940 or the deployment module 950. The datastore 970 may further store data generated by the ZKP module 960, such as canonical weights, verified outputs, and so on. The datastore 970 may include one or more memories. In the embodiment of FIG. 9, the datastore 970 is a component of the transformer module 902. In other embodiments, the datastore 970 may be external to the transformer module 902 and communicate with the transformer module 902 through a network or interconnect fabric.

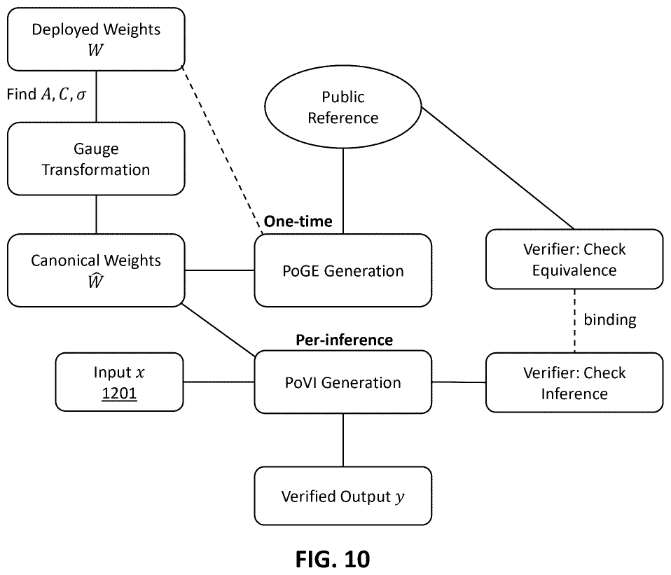

FIG. 10 illustrates a two-stage proof architecture, in accordance with various embodiments. The two-stage proof architecture may be an example architecture of ZKP for verifying transformer model inference, such as ZKP established by the ZKP module 960 described above in conjunction with FIG. 9. The two-stage proof architecture leverages gauge symmetry in attention mechanisms of transformer models to establish ZKP. The two-stage proof architecture includes a first stage of PoGE generation and a second stage of PoVI generation.

The PoGE can establish that deployed weights W′ are functionally identical to canonical weights Ŵ through gauge transformations. This proof may execute once per model deployment and demonstrates knowledge of transformation matrices without revealing them. The PoGE generation may be performed by the PoGE module 963 in FIG. 9. As shown in FIG. 10, the PoGE generation is based on deployed weights W. The deployed weights W may be weights of the deployed model, i.e., the transformer model that is executed to perform the AI tasks. Gauge transformation is performed on the deployed weights W by using A, C and σ. The gauge transformation results in canonical weights Ŵ, which may be a canonical form of the deployed weights W. This canonical form serves as a unique representative within each equivalence class of functionally identical parameters, selected through a deterministic algorithm that balances query-key Gram matrices and orthonormalizes value projections.

The canonical weights Ŵ may serve as PoGE, which is part of the ZKP. The PoGE generation may be performed once for a deployed transformer model. The PoGE may be used for verifying multiple transformer model inference processes. For instance, a transformer model is deployed multiple times to process multiple inputs. The same PoGE may be used to verify the transformer model inference for all these inputs.

After the first stage, the PoVI may operate exclusively on the canonical weights in the second stage, verifying that outputs follow correctly from inputs without redundant parameter constraints. The PoVI generation may be performed by the PoVI module 965 in FIG. 9. The PoVI generation is based on the canonical weights Ŵ. The PoVI generation may involve a process of executing the canonical form of the transformer model using an input x. The canonical form of the transformer model may be canonical model that has the layers of the transformer model but have the canonical weights Ŵ in lieu of the deployed weights W. In some embodiments, the input x may be the same as the input used to deploy the transformer model for performing the AI tasks. The input x may be encrypted. In other embodiments, the input x may be different from the input used to deploy the transformer model for performing the AI tasks. The inference of the canonical model produces a verified output y. The verified output y may be part of the PoVI.

A verifier, an example of which may be the verifier 820 in FIG. 8, may check equivalence based on a public reference and check inference based on PoVI. The public reference may include model hash, data, output, etc. The verifier may be convinced by the correctness of the transformer model inference using the deployed weights W, even though the deployed weights W are not shared with the verifier.

This gauge symmetry approach can uniquely balance the competing demands of transparency and intellectual property protection. Companies investing millions in model development can now prove their systems operate correctly without exposing the specific parameter values that encode their competitive advantages. The canonical form abstraction can allow verification against publicly audited reference models while keeping actual deployment parameters private, creating a technically enforceable boundary between verification and reverse engineering.

The two-stage proof architecture can fundamentally restructure how verification occurs. This approach can establish a canonical form for transformer weights through a systematic gauge-fixing procedure. The value-output pathway optimization can employ QR decomposition to transform value matrices into orthonormal form, reducing invertibility verification from thousands of multiplication gates to simple dot product checks. This technique alone can provide significant gate reduction when combined with low-rank output projections.

This approach can support architectural variants including multi-query attention and grouped-query attention, which naturally reduces verification complexity by sharing value matrices across attention heads. These architectural adaptations can combine synergistically with gauge optimization, demonstrating that the framework accommodates diverse transformer variants while maintaining mathematical rigor. The randomized orthonormality verification with single projection can achieve parity with generic verification while preserving exactness, representing a significant algorithmic contribution that makes value-output optimization practical at scale.

This approach has various advantages that distinguish it from laboratory demonstrations. The amortization model can create favorable economics where one-time gauge equivalence proof costs distribute across potentially millions of inference requests. The gauge equivalence proof can be generated during model deployment, a process requiring less than ten seconds for models with hundreds of millions of parameters, then leverage this proof indefinitely for subsequent inferences.

The modular proof architecture can enable flexible deployment patterns that accommodate different operational requirements. Cloud service providers can maintain canonical weight references and generate inference proofs on behalf of customers, while enterprises requiring maximum security can operate their own proving infrastructure. The separation between gauge equivalence and inference proofs also enables specialized service providers to emerge, with some focusing on efficient gauge transformation computation while others optimize inference verification.

FIG. 11 illustrates advantages of two-stage ZKP for circuit implementation, in accordance with various embodiments. State-of-art proof typically has O(n) constraints, where n represents the parameter count, as it requires all parameters, such as all the deployed weights W. In contrast, after one-time PoGE is generated through gauge transformation, the two-stage ZKP may execute through canonical model inference, which uses canonical weights Ŵ, that results in O(n−h(d²)) constraints. Two-stage ZKP can be effective across multiple model architectures and scales. In the example of FIG. 11, there is a reduction from 198 million gates using the traditional approach to 63 million gates using gauge optimization, representing a 68% improvement.

Transformers typically exhibit continuous gauge symmetries within their attention mechanisms, particularly in the query-key and value-output pathways, but state-of-art proof systems lack the mathematical framework to exploit these symmetries for computational reduction. State-of-art proof approaches usually share a common limitation in that they fail to recognize and exploit the gauge symmetry structure inherent in transformer architectures. They usually treat the parameter space as flat and unstructured, missing the mathematical insight that large equivalence classes of parameters compute identical functions. By continuing to verify redundant parameters that do not affect model output, these approaches can waste computational resources on mathematically unnecessary constraints. The introduction of gauge-theoretic optimization in the two-stage ZKP approach of this disclosure can represent a fundamental departure from these previous approaches, addressing the problem at its algebraic root rather than attempting to optimize around it through engineering or approximation.

Many state-of-the-art proof systems require proof generation times that scale as O(n), resulting in hours of computation for models with billions of parameters. Memory requirements similarly scale linearly, often exceeding available resources for production-scale models. The verification costs make real-time or near-real-time proof generation impossible for interactive applications. The technical problem creates a significant barrier to regulatory compliance and trustworthy AI deployment in critical sectors. Financial institutions, healthcare providers, and government agencies require verifiable guarantees that AI model outputs are computed correctly without exposing proprietary model weights or sensitive input data. The excessive computational costs of existing proof systems have prevented these organizations from deploying verifiable inference at scale, limiting the adoption of transformer models in regulated industries where auditability and verification are mandatory requirements. The innovation's solution to eliminate redundant parameter verification through gauge symmetry exploitation represents a paradigm shift from optimizing cryptographic protocols to reducing the inherent algebraic complexity of the verification task itself. This approach achieves up to 26% reduction in verification costs while maintaining exact functional equivalence and zero-knowledge properties, making production deployment of verifiable transformer inference economically viable for the first time.

The circuit implementation of two-stage ZKP may exploit the algebraic structure of gauge transformations to minimize verification complexity. Instead of verifying full matrix multiplications with cubic complexity, the system may employ randomized linear combination checks that reduce verification to linear complexity while maintaining cryptographic soundness. The implementation may use Fiat-Shamir challenges to generate random vectors, then verify that transformed matrices satisfy required relationships when projected onto these random subspaces. For instance, Fiat-Shamir transformation may take on an interactive proof of knowledge and create a digital signature based on it. This way, some facts (for example, embedding vectors) can be publicly proven without revealing underlying information. The implementation can carefully manage witness generation to minimize memory consumption, using streaming techniques that process transformer layers sequentially rather than maintaining entire model states in memory simultaneously.

For architectures employing ROPE, the system may adapt to the restricted gauge structure by working within the commutant algebra of rotation matrices. This may require specialized constraints that verify transformation matrices maintain compatibility with position-dependent rotations while still eliminating redundancy. These engineering optimizations, combined with the fundamental mathematical insights, create a practical system capable of verifying billion-parameter models on commodity hardware.

The mathematical elegance of this approach can ensure that optimization benefits persist even under architectural constraints. When combined with existing frameworks like EZKL, the two-stage ZKP approach can provide multiplicative benefits, reducing proving time by seventy-seven percent while maintaining exact functional equivalence. The benefits of two-stage ZKP can increase with model size, as the number of redundant parameters grows quadratically with hidden dimensions. For some large models, the two-stage ZKP approach can eliminate over 33 million redundant parameters from verification, reducing total circuit complexity by 26% at model scale.

The circuit implementation can leverage advanced cryptographic techniques to maximize efficiency while maintaining security. The system can operate in a large prime field with fixed-point arithmetic using scale factor (e.g., 2\hat{ }16), providing sufficient precision for transformer computations while avoiding overflow in field arithmetic. Non-linear operations including exponentials and square roots can utilize precomputed look-up tables, eliminating expensive in-circuit computation of transcendental functions.

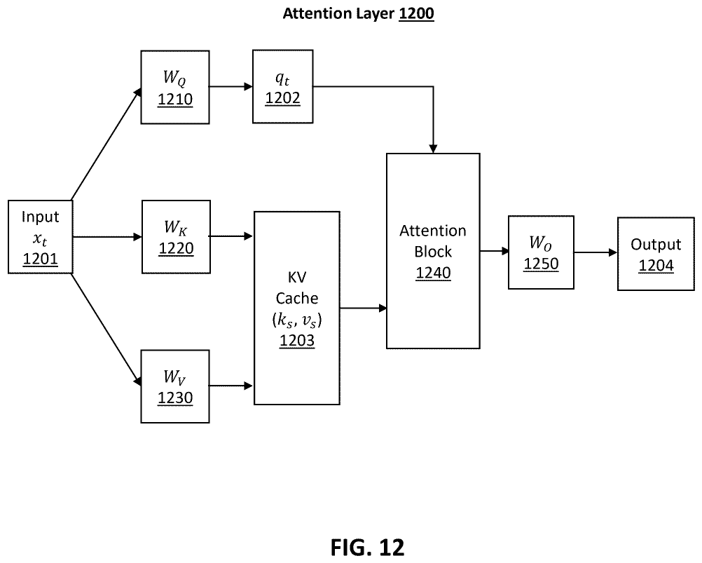

FIG. 12 illustrates a dataflow in an attention layer 1200 during transformer model inference for deployment, in accordance with various embodiments. The attention layer 1200 may be a layer in a transformer model that is deployed to perform an AI task. Examples of the attention layer 1200 may include the MHA layer 141 in FIG. 1, MHA layer 151 in FIG. 1, MHA layer 153 in FIG. 1, and MHA layer 400 in FIG. 4A.

As shown in FIG. 12, the attention layer 1200 receives an input 1201. The input 1201 is denoted as xₜ, which may be a tensor of token embeddings. The input 1201 is fed into MatMul layer 1210, MatMul layer 1220, and MatMul layer 1230. Each of the MatMul layer 1210, MatMul layer 1220, and MatMul layer 1230 receives the input 1201. The MatMul layer 1210 has a query weight matrix W_{Q}, the MatMul layer 1220 has a key weight matrix W_{K}, and the MatMul layer 1230 has a value weight matrix W_{V}. An example of the MatMul layer 1210 may be the linear layer 410 in FIG. 4A. An example of the MatMul layer 1220 may be the linear layer 420 in FIG. 4A. An example of the MatMul layer 1230 may be the linear layer 430 in FIG. 4A. The MatMul layer 1210 outputs a query matrix 1202, which is denoted as qₜ. The MatMul layer 1220 and MatMul layer 1230 outputs a key matrix kₛ and a value matrix vₛ, respectively, which are stored in a KV cache 1203.

The KV data in the KV cache 1203 is fed into an attention block 1240 for further computation. An example of the attention block 1240 is the attention block 425 in FIG. 4A. The output of the attention block 1240 is fed into a MatMul layer 1250, which has an output weight matrix W_{O}. An example of the MatMul layer 1250 may be the linear layer 490 in FIG. 4A. In the MatMul layer 1250, an MatMul operation is performed on the output of the attention block 1240 and the output weight matrix W_{O}, resulting in an output 1204. The weight matrices in FIG. 12 may be determined by training the transformer model.

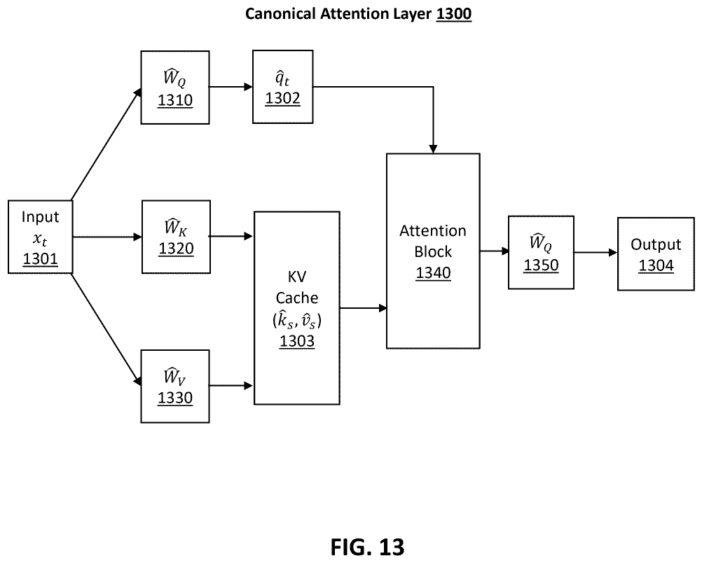

FIG. 13 illustrates a dataflow in an attention layer 1300 during canonical model inference for verification, in accordance with various embodiments. The attention layer 1300 may be generated by transforming an attention layer of a deployed transformer model (e.g., the attention layer 1200 in FIG. 12) through gauge transformation.

As shown in FIG. 13, the attention layer 1300 receives an input 1301. The input 1301 is denoted as xₜ, which may be a tensor of token embeddings. In an example, the input 1301 is an embedding vector. In some embodiments, the input 1301 may be generated using Fiat-Shamir transformation. For instance, the input 1301 may be random vectors generated by the PoVI module 965 in FIG. 9. The prover (e.g., the ZKP module 960 in FIG. 9) may commit to a value without revealing proprietary information. The verifier (e.g., the verifier 820 in FIG. 8) may send a random challenge to the prover. The prover may use the challenge to generate a response, which the verifier checks to confirm whether the computations in the transformer model inference for deployment were correct. The input 1301 may be the random challenge that the prover receives from the verifier.

The input 1301 is fed into MatMul layer 1310, MatMul layer 1320, and MatMul layer 1330. Each of the MatMul layer 1310, MatMul layer 1320, and MatMul layer 1330 receives the input 1301. The MatMul layer 1310 has a query weight matrix Ŵ_{O}, the MatMul layer 1320 has a key weight matrix Ŵ_{K}, and the MatMul layer 1330 has a value weight matrix Ŵ_{V}. The MatMul layer 1310 may be converted from the MatMul layer 1210 by replacing the query weight matrix W_{Q} with the query weight matrix Ŵ_{Q}. The MatMul layer 1320 may be converted from the MatMul layer 1220 by replacing the key weight matrix W_{K} with the key weight matrix Ŵ_{K}. The MatMul layer 1330 may be converted from the MatMul layer 1230 by replacing the value weight matrix W_{V} with the value weight matrix Ŵ_{V}. The MatMul layer 1310 outputs a query matrix 1302, which is denoted as qₜ. The MatMul layer 1320 and MatMul layer 1330 outputs a key matrix kₛ and a value matrix vₛ, respectively, which are stored in a KV cache 1303.

The KV data in the KV cache 1303 is fed into an attention block 1340 for further computation. An example of the 1340 is the attention block 425 in FIG. 4A. The output of the attention block 1340 is fed into a MatMul layer 1350, which has an output weight matrix Ŵ_{O}. The MatMul layer 1350 may be converted from the MatMul layer 1250 by replacing the output weight matrix W_{O} with the output weight matrix Ŵ_{O}. In the MatMul layer 1350, an MatMul operation is performed on the output of the attention block 1340 and the output weight matrix W_{O}, resulting in an output 1304. The weight matrices in FIG. 13 (i.e., Ŵ_{O}, Ŵ_{K}, Ŵ_{V}, and Ŵ_{Q}) may be canonical weights that are determined by canonicalizing weight matrices of the attention layer 1200 in FIG. 12. The output 1304 may be a verified output that the verifier can use to confirm that the computations in the attention layer 1200 for deployment were correct.

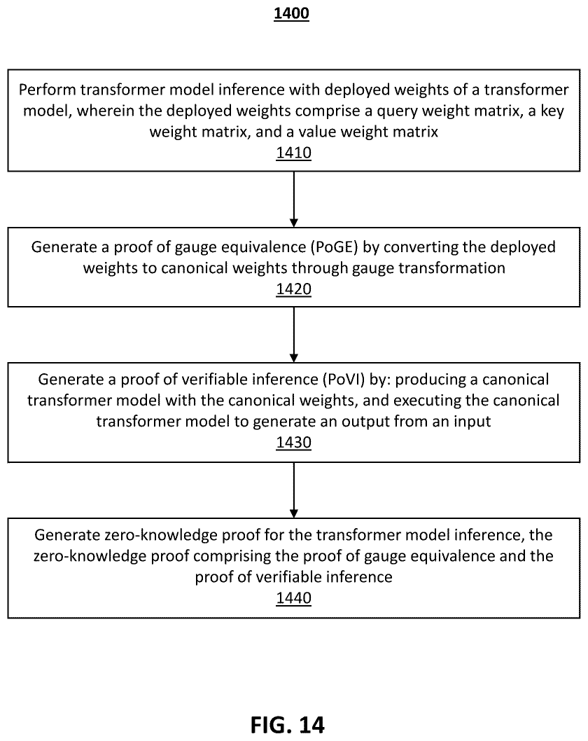

FIG. 14 is a flowchart of a method 1400 for proving correctness of transformer model inference, in accordance with various embodiments. The method 1400 may be performed by the AI system 900 in FIG. 10. Although the method 1400 is described with reference to the flowchart illustrated in FIG. 14, many other methods for proving correctness of transformer model inference may alternatively be used. For example, the order of execution of the steps in FIG. 14 may be changed. As another example, some of the steps may be changed, eliminated, or combined.

The AI system 900 performs 1410 transformer model inference with deployed weights of a transformer model. The deployed weights comprise a query weight matrix, a key weight matrix, and a value weight matrix.

The AI system 900 generates 1420 PoGE by converting the deployed weights to canonical weights through gauge transformation. In some embodiments, the AI system 900 transforms a query weight matrix and a key weight matrix of an attention layer of the transformer model based on a first transformation matrix. The AI system 900 transforms a value weight matrix of the attention layer based on a second transformation matrix. In some embodiments, the AI system 900 transforms the query weight matrix using the first transformation matrix and transforms the key weight matrix using an inverse of a transpose of the first transformation matrix. In some embodiments, the attention layer further has an output weight matrix. The AI system 900 transforms the output weight matrix based on the second transformation matrix. In some embodiments, the value weight matrix is transformed using the second transformation matrix, and the output weight matrix is transformed using an inverse of the second transformation matrix.

In some embodiments, the transformer model has ROPE. The AI system 900 divides a dimension of the key weight matrix into a plurality of matrix blocks. The AI system 900 determines the first transformation matrix based on the plurality of matrix blocks.

The AI system 900 generates 1430 PoVI by producing a canonical transformer model with the canonical weights and executing the canonical transformer model to generate an output from an input. In some embodiments, the AI system 900 generates the input through Fiat-Shamir transformation. The input comprises a random vector. In some embodiments, the query weight matrix, the key weight matrix, or the value weight matrix is a weight matrix of an attention layer, the attention layer having a plurality of heads. An order of the plurality of heads in the transformer model is different from an order of the plurality of heads in the canonical transformer model.

The AI system 900 generates 1440 ZKP for the transformer model inference. The ZKP comprises the PoGE and the PoVI. In some embodiments, deploying the transformer model further comprises performing an additional transformer model inference. The AI system 900 generates an additional ZKP for the additional transformer model inference. The additional ZKP comprises the PoGE. In some embodiments, the AI system 900 generates an additional PoVI by executing the canonical transformer model to generate an additional output from an additional input. The additional ZKP further comprises the additional PoVI.

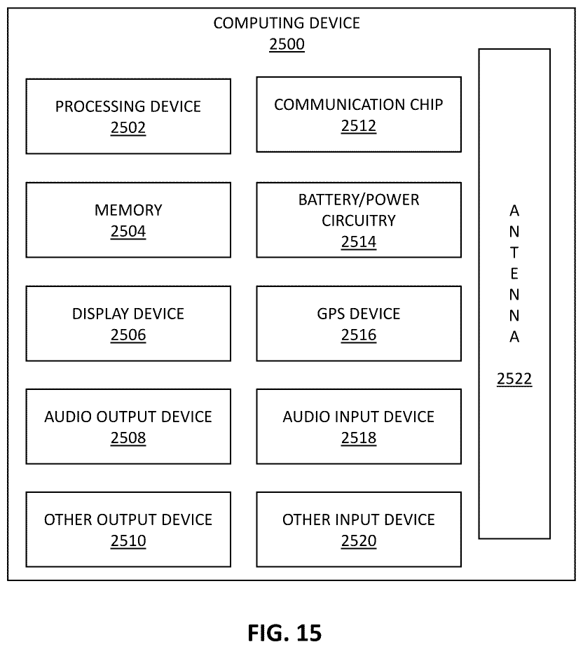

FIG. 15 is a block diagram of an example computing device 2500, in accordance with various embodiments. In some embodiments, the computing device 2500 can be used as at least part of the AI system 900 in FIG. 9. A number of components are illustrated in FIG. 15 as included in the computing device 2500, but any one or more of these components may be omitted or duplicated, as suitable for the application. In some embodiments, some or all of the components included in the computing device 2500 may be attached to one or more motherboards. In some embodiments, some or all of these components are fabricated onto a single system on a chip (SoC) die. Additionally, in various embodiments, the computing device 2500 may not include one or more of the components illustrated in FIG. 15, but the computing device 2500 may include interface circuitry for coupling to the one or more components. For example, the computing device 2500 may not include a display device 2506, but may include display device interface circuitry (e.g., a connector and driver circuitry) to which a display device 2506 may be coupled. In another set of examples, the computing device 2500 may not include an audio input device 2518 or an audio output device 2508 but may include audio input or output device interface circuitry (e.g., connectors and supporting circuitry) to which an audio input device 2518 or audio output device 2508 may be coupled.

The computing device 2500 may include a processing device 2502 (e.g., one or more processing devices). The processing device 2502 processes electronic data from registers and/or memory to transform that electronic data into other electronic data that may be stored in registers and/or memory. The computing device 2500 may include a memory 2504, which may itself include one or more memory devices such as volatile memory (e.g., DRAM), nonvolatile memory (e.g., read-only memory (ROM)), HBM, flash memory, solid state memory, and/or a hard drive. In some embodiments, the memory 2504 may include memory that shares a die with the processing device 2502. In some embodiments, the memory 2504 includes one or more non-transitory computer-readable media storing instructions executable to perform operations for verifying correctness of transformer model inference (e.g., the method 1400 described in conjunction with FIG. 14) or some operations performed by one or more components of the AI system 900 in FIG. 9. The instructions stored in the one or more non-transitory computer-readable media may be executed by the processing device 2502.

In some embodiments, the computing device 2500 may include a communication chip 2512 (e.g., one or more communication chips). For example, the communication chip 2512 may be configured for managing wireless communications for the transfer of data to and from the computing device 2500. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2512 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2512 may operate in accordance with other wireless protocols in other embodiments. The computing device 2500 may include an antenna 2522 to facilitate wireless communications and/or to receive other wireless communications (such as AM or FM radio transmissions).

In some embodiments, the communication chip 2512 may manage wired communications, such as electrical, optical, or any other suitable communication protocols (e.g., the Ethernet). As noted above, the communication chip 2512 may include multiple communication chips. For instance, a first communication chip 2512 may be dedicated to shorter-range wireless communications such as Wi-Fi or Bluetooth, and a second communication chip 2512 may be dedicated to longer-range wireless communications such as global positioning system (GPS), EDGE, GPRS, CDMA, WiMAX, LTE, EV-DO, or others. In some embodiments, a first communication chip 2512 may be dedicated to wireless communications, and a second communication chip 2512 may be dedicated to wired communications.

The computing device 2500 may include battery/power circuitry 2514. The battery/power circuitry 2514 may include one or more energy storage devices (e.g., batteries or capacitors) and/or circuitry for coupling components of the computing device 2500 to an energy source separate from the computing device 2500 (e.g., AC line power).

The computing device 2500 may include a display device 2506 (or corresponding interface circuitry, as discussed above). The display device 2506 may include any visual indicators, such as a heads-up display, a computer monitor, a projector, a touchscreen display, a liquid crystal display (LCD), a light-emitting diode display, or a flat panel display, for example.

The computing device 2500 may include an audio output device 2508 (or corresponding interface circuitry, as discussed above). The audio output device 2508 may include any device that generates an audible indicator, such as speakers, headsets, or earbuds, for example.

The computing device 2500 may include an audio input device 2518 (or corresponding interface circuitry, as discussed above). The audio input device 2518 may include any device that generates a signal representative of a sound, such as microphones, microphone arrays, or digital instruments (e.g., instruments having a musical instrument digital interface (MIDI) output).

The computing device 2500 may include a GPS device 2516 (or corresponding interface circuitry, as discussed above). The GPS device 2516 may be in communication with a satellite-based system and may receive a location of the computing device 2500, as known in the art.

The computing device 2500 may include another output device 2510 (or corresponding interface circuitry, as discussed above). Examples of the other output device 2510 may include an audio codec, a video codec, a printer, a wired or wireless transmitter for providing information to other devices, or an additional storage device.

The computing device 2500 may include another input device 2520 (or corresponding interface circuitry, as discussed above). Examples of the other input device 2520 may include an accelerometer, a gyroscope, a compass, an image capture device, a keyboard, a cursor control device such as a mouse, a stylus, a touchpad, a bar code reader, a Quick Response code reader, any sensor, or a radio frequency identification (RFID) reader.

The computing device 2500 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2500 may be any other electronic device that processes data.

The following paragraphs provide additional examples of the embodiments disclosed herein.

Example 1 provides one or more non-transitory computer-readable media storing instructions executable to perform operations for verifying a transformer model inference, the operations including performing transformer model inference with deployed weights of a transformer model, wherein the deployed weights comprise a query weight matrix, a key weight matrix, and a value weight matrix; generating proof of gauge equivalence (PoGE) by converting the deployed weights to canonical weights through gauge transformation; generating proof of verifiable inference (PoVI) by: producing a canonical transformer model with the canonical weights, and executing the canonical transformer model to generate an output from an input; and generating zero-knowledge proof for the transformer model inference, the zero-knowledge proof including the PoGE and the PoVI.

Example 2 provides the one or more non-transitory computer-readable media of example 1, in which deploying the transformer model further includes performing an additional transformer model inference, in which the operations further include generating an additional zero-knowledge proof for the additional transformer model inference, the additional zero-knowledge proof including the PoGE.

Example 3 provides the one or more non-transitory computer-readable media of example 2, in which the operations further include generating an additional PoVI by executing the canonical transformer model to generate an additional output from an additional input, in which the additional zero-knowledge proof further includes the additional PoVI.

Example 4 provides the one or more non-transitory computer-readable media of any one of examples 1-3, in which the operations further include generating the input through Fiat-Shamir transformation, in which the input includes a random vector.

Example 5 provides the one or more non-transitory computer-readable media of any one of examples 1-4, in which the query weight matrix, the key weight matrix, or the value weight matrix is a weight matrix of an attention layer, the attention layer having a plurality of heads, in which an order of the plurality of heads in the transformer model is different from an order of the plurality of heads in the canonical transformer model.

Example 6 provides the one or more non-transitory computer-readable media of any one of examples 1-5, in which converting the deployed weights to the canonical weights includes transforming a query weight matrix and a key weight matrix of an attention layer of the transformer model based on a first transformation matrix, and transforming a value weight matrix of the attention layer based on a second transformation matrix.

Example 7 provides the one or more non-transitory computer-readable media of example 6, in which the transformer model has rotary position embeddings, in which the operations further include dividing a dimension of the key weight matrix into a plurality of matrix blocks; and determining the first transformation matrix based on the plurality of matrix blocks.

Example 8 provides the one or more non-transitory computer-readable media of example 6 or 7, in which transforming the query weight matrix and the key weight matrix includes transforming the query weight matrix using the first transformation matrix; and transforming the key weight matrix using an inverse of a transpose of the first transformation matrix.

Example 9 provides the one or more non-transitory computer-readable media of any one of examples 6-8, in which the attention layer further has an output weight matrix, in which converting the deployed weights to the canonical weights further includes transforming the output weight matrix based on the second transformation matrix.

Example 10 provides the one or more non-transitory computer-readable media of example 9, in which the value weight matrix is transformed using the second transformation matrix, in which the output weight matrix is transformed using an inverse of the second transformation matrix.

Example 11 provides a method for verifying a transformer model inference, the method including performing transformer model inference with deployed weights of a transformer model, wherein the deployed weights comprise a query weight matrix, a key weight matrix, and a value weight matrix; generating proof of gauge equivalence (PoGE) by converting the deployed weights to canonical weights through gauge transformation; generating proof of verifiable inference (PoVI) by: producing a canonical transformer model with the canonical weights, and executing the canonical transformer model to generate an output from an input; and generating zero-knowledge proof for the transformer model inference, the zero-knowledge proof including the PoGE and the PoVI.

Example 12 provides the method of example 11, in which deploying the transformer model further includes performing an additional transformer model inference, in which the method further includes generating an additional zero-knowledge proof for the additional transformer model inference, the additional zero-knowledge proof including the PoGE.

Example 13 provides the method of example 12, further including generating an additional PoVI by executing the canonical transformer model to generate an additional output from an additional input, in which the additional zero-knowledge proof further includes the additional PoVI.

Example 14 provides the method of any one of examples 11-13, further including generating the input through Fiat-Shamir transformation, in which the input includes a random vector.

Example 15 provides the method of any one of examples 11-14, in which the query weight matrix, the key weight matrix, or the value weight matrix is a weight matrix of an attention layer, the attention layer having a plurality of heads, in which an order of the plurality of heads in the transformer model is different from an order of the plurality of heads in the canonical transformer model.

Example 16 provides the method of any one of examples 11-15, in which converting the deployed weights to the canonical weights includes transforming a query weight matrix and a key weight matrix of an attention layer of the transformer model based on a first transformation matrix, and transforming a value weight matrix of the attention layer based on a second transformation matrix.

Example 17 provides the method of example 16, in which the transformer model has rotary position embeddings, further including dividing a dimension of the key weight matrix into a plurality of matrix blocks; and determining the first transformation matrix based on the plurality of matrix blocks.

Example 18 provides the method of example 16 or 17, in which transforming the query weight matrix and the key weight matrix includes transforming the query weight matrix using the first transformation matrix; and transforming the key weight matrix using an inverse of a transpose of the first transformation matrix.

Example 19 provides the method of any one of examples 16-18, in which the attention layer further has an output weight matrix, in which converting the deployed weights to the canonical weights further includes transforming the output weight matrix based on the second transformation matrix.

Example 20 provides the method of example 19, in which the value weight matrix is transformed using the second transformation matrix, in which the output weight matrix is transformed using an inverse of the second transformation matrix.

Example 21 provides an apparatus, including a computer processor for executing computer program instructions; and a non-transitory computer-readable memory storing computer program instructions executable by the computer processor to perform operations for verifying a transformer model inference, the operations including performing transformer model inference with deployed weights of a transformer model, wherein the deployed weights comprise a query weight matrix, a key weight matrix, and a value weight matrix, generating proof of gauge equivalence (PoGE) by converting the deployed weights to canonical weights through gauge transformation, generating proof of verifiable inference (PoVI) by: producing a canonical transformer model with the canonical weights, and executing the canonical transformer model to generate an output from an input, and generating zero-knowledge proof for the transformer model inference, the zero-knowledge proof including the PoGE and the PoVI.

Example 22 provides the apparatus of example 21, in which deploying the transformer model further includes performing an additional transformer model inference, in which the operations further include generating an additional zero-knowledge proof for the additional transformer model inference, the additional zero-knowledge proof including the PoGE.

Example 23 provides the apparatus of example 22, in which the operations further include generating an additional proof of verifiable inference by executing the canonical transformer model to generate an additional output from an additional input, in which the additional zero-knowledge proof further includes the additional PoVI.

Example 24 provides the apparatus of any one of examples 21-23, in which the operations further include generating the input through Fiat-Shamir transformation, in which the input includes a random vector.

Example 25 provides the apparatus of any one of examples 21-24, in which the query weight matrix, the key weight matrix, or the value weight matrix is a weight matrix of an attention layer, the attention layer having a plurality of heads, in which an order of the plurality of heads in the transformer model is different from an order of the plurality of heads in the canonical transformer model.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. One or more non-transitory computer-readable media storing instructions executable to perform operations for verifying a transformer model inference, the operations comprising:
performing transformer model inference with deployed weights of a transformer model, wherein the deployed weights comprise a query weight matrix, a key weight matrix, and a value weight matrix;
generating proof of gauge equivalence (PoGE) by converting the deployed weights to canonical weights through gauge transformation;
generating proof of verifiable inference (PoVI) by:
producing a canonical transformer model with the canonical weights, and
executing the canonical transformer model to generate an output from an input; and
generating zero-knowledge proof for the transformer model inference, the zero-knowledge proof comprising the PoGE and the PoVI.

2. The one or more non-transitory computer-readable media of claim 1, wherein deploying the transformer model further comprises performing an additional transformer model inference, wherein the operations further comprise generating an additional zero-knowledge proof for the additional transformer model inference, the additional zero-knowledge proof comprising the PoGE.

3. The one or more non-transitory computer-readable media of claim 2, wherein the operations further comprise:
generating an additional PoVI by executing the canonical transformer model to generate an additional output from an additional input,
wherein the additional zero-knowledge proof further comprises the additional PoVI.

4. The one or more non-transitory computer-readable media of claim 1, wherein the operations further comprise:
generating the input through Fiat-Shamir transformation, wherein the input comprises a random vector.

5. The one or more non-transitory computer-readable media of claim 1, wherein the query weight matrix, the key weight matrix, or the value weight matrix is a weight matrix of an attention layer, the attention layer having a plurality of heads, wherein an order of the plurality of heads in the transformer model is different from an order of the plurality of heads in the canonical transformer model.

6. The one or more non-transitory computer-readable media of claim 1, wherein converting the deployed weights to the canonical weights comprises:
transforming a query weight matrix and a key weight matrix of an attention layer of the transformer model based on a first transformation matrix, and
transforming a value weight matrix of the attention layer based on a second transformation matrix.

7. The one or more non-transitory computer-readable media of claim 6, wherein the transformer model has rotary position embeddings, wherein the operations further comprise:
dividing a dimension of the key weight matrix into a plurality of matrix blocks; and
determining the first transformation matrix based on the plurality of matrix blocks.

8. The one or more non-transitory computer-readable media of claim 6, wherein transforming the query weight matrix and the key weight matrix comprises:
transforming the query weight matrix using the first transformation matrix; and
transforming the key weight matrix using an inverse of a transpose of the first transformation matrix.

9. The one or more non-transitory computer-readable media of claim 6, wherein the attention layer further has an output weight matrix, wherein converting the deployed weights to the canonical weights further comprises transforming the output weight matrix based on the second transformation matrix.

10. The one or more non-transitory computer-readable media of claim 9, wherein the value weight matrix is transformed using the second transformation matrix, wherein the output weight matrix is transformed using an inverse of the second transformation matrix.

11. A method for verifying a transformer model inference, the method comprising:
performing transformer model inference with deployed weights of a transformer model, wherein the deployed weights comprise a query weight matrix, a key weight matrix, and a value weight matrix;
generating proof of gauge equivalence (PoGE) by converting the deployed weights to canonical weights through gauge transformation;
generating proof of verifiable inference (PoVI) by:
producing a canonical transformer model with the canonical weights, and
executing the canonical transformer model to generate an output from an input; and
generating zero-knowledge proof for the transformer model inference, the zero-knowledge proof comprising the PoGE and the PoVI.

12. The method of claim 11, wherein deploying the transformer model further comprises performing an additional transformer model inference, wherein the method further comprises generating an additional zero-knowledge proof for the additional transformer model inference, the additional zero-knowledge proof comprising the proof of gauge equivalence.

13. The method of claim 12, further comprising:
generating an additional PoVI by executing the canonical transformer model to generate an additional output from an additional input,
wherein the additional zero-knowledge proof further comprises the additional PoVI.

14. The method of claim 11, further comprising:
generating the input through Fiat-Shamir transformation, wherein the input comprises a random vector.

15. The method of claim 11, wherein the query weight matrix, the key weight matrix, or the value weight matrix is a weight matrix of an attention layer, the attention layer having a plurality of heads, wherein an order of the plurality of heads in the transformer model is different from an order of the plurality of heads in the canonical transformer model.

16. The method of claim 11, wherein converting the deployed weights to the canonical weights comprises:
transforming a query weight matrix and a key weight matrix of an attention layer of the transformer model based on a first transformation matrix, and
transforming a value weight matrix of the attention layer based on a second transformation matrix.

17. An apparatus, comprising:
a computer processor for executing computer program instructions; and
a non-transitory computer-readable memory storing computer program instructions executable by the computer processor to perform operations for verifying a transformer model inference, the operations comprising:
performing transformer model inference with deployed weights of a transformer model, wherein the deployed weights comprise a query weight matrix, a key weight matrix, and a value weight matrix,
generating proof of gauge equivalence (PoGE) by converting the deployed weights to canonical weights through gauge transformation,
generating proof of verifiable inference (PoVI) by:
producing a canonical transformer model with the canonical weights, and
executing the canonical transformer model to generate an output from an input, and
generating zero-knowledge proof for the transformer model inference, the zero-knowledge proof comprising the PoGE and the PoVI.

18. The apparatus of claim 17, wherein deploying the transformer model further comprises performing an additional transformer model inference, wherein the operations further comprise generating an additional zero-knowledge proof for the additional transformer model inference, the additional zero-knowledge proof comprising the PoGE.

19. The apparatus of claim 18, wherein the operations further comprise:
generating an additional PoVI by executing the canonical transformer model to generate an additional output from an additional input,
wherein the additional zero-knowledge proof further comprises the additional PoVI.

20. The apparatus of claim 17, wherein the query weight matrix, the key weight matrix, or the value weight matrix is a weight matrix of an attention layer, the attention layer having a plurality of heads, wherein an order of the plurality of heads in the transformer model is different from an order of the plurality of heads in the canonical transformer model.
